(19) United States
(12) Patent Application Publication
(10) Pub. No.: US 2025/0165812 A1
(43) Pub. Date: May 22, 2025

(54) SYSTEMS AND METHODS FOR USING ARTIFICIAL INTELLIGENCE TO PREDICT RECIPES FOR A FOOD PRODUCT

(71) Applicant: INTERCONTINENTAL GREAT BRANDS LLC, East Hanover, NJ (US)

(72) Inventors: Henrique Favre, Curitiba (BR); Andrew Carlos Kondlatsch, Curitiba (BR); Vladamir Metodiev, Amsterdam (NL); Emma Kämäräinen, Helsinki (FI)

(21) Appl. No.: 18/517,864

(22) Filed: Nov. 22, 2023

(51) Int. Cl. G06N 5/022

(52) U.S. Cl. CPC G06N 5/022

(57) ABSTRACT

A software tool for predicting candidate recipes for a food product using (a) a predictor model that is trained to output, for a given candidate recipe that is passed as input to the predictive model, (i) a predicted value of at least one target variable and (ii) predicted values of a given subset of assessment variables, and (b) a generator model that functions to: (1) train an underlying predictive model that is configured to output (i) predicted values of the at least one target variable for a space of possible recipes and (ii) uncertainty estimates for the predicted values, and (2) select candidate recipes from the space of possible recipes based on (i) a balancing between the predicted values and the uncertainty estimates output by the underlying predictive model and (ii) the set of constraints.

### BACKGROUND

Developing food products that are to be sold commercially (e.g., snack products, canned food products, candy and gum products, soft drink products, etc.) can be a complex, time consuming, and costly endeavor that requires balancing of a wide range of different factors. For instance, when a company is working to develop a recipe for a food product that is to be sold commercially, the company must balance factors such as consumer enjoyment, cost, safety, environmental impact, speed to market, producibility at scale, availability of ingredients, and/or regulatory requirements, among others. As a result, the product development cycle for a food product typically requires a team of many different individuals that work over the course of months or years to come up with a recipe that strikes an acceptable balance between multiple different factors through trial and error—and even then, due to the practical constraints on a human's creativity, knowledge, and ability to balance multiple different factors that can each have a range of acceptable values, there is often a universe of other recipe options that are never even considered or explored, which may lead to sub-optimal results.

### SUMMARY

Disclosed herein is a new software tool for predicting, evaluating, and managing candidate recipes for a food product.

In one aspect, the disclosed technology may take the form of a method to be carried out by a computing platform that involves (a) receiving, from a first client device via a first communication path comprising at least one data network, an indication of configuration parameters for predicting candidate recipes for a food product, wherein the configuration parameters include at least (i) a set of ingredients to include in the candidate recipes, (ii) at least one target variable for the candidate recipes, (iii) a set of constraints for the candidate recipes, and (iv) a set of assessment variables that are to be evaluated during testing of the candidate recipes, (b) based on a first subset of the configuration parameters and a first set of training data, training a predictor model that is configured to output, for a given candidate recipe that is passed as input to the predictive model, (i) a predicted value of the at least one target variable and (ii) predicted values of a given subset of the assessment variables, (c) configuring a generator model that functions to: (1) based on a second subset of the configuration parameters and a second set of training data, training an underlying predictive model that is configured to output (i) predicted values of the at least one target variable for a space of possible recipes and (ii) uncertainty estimates for the predicted values; and (2) selecting candidate recipes from the space of possible recipes based on (i) a balancing between the predicted values and the uncertainty estimates output by the underlying predictive model and (ii) the set of constraints, (d) utilizing the generator model and the predictor model to select, from the space of possible recipes, a first group of candidate recipes for the food product; and (e) transmitting, to a second client device via a second communication path comprising at least one data network, one or more messages that collectively cause the second client device to display the first group of candidate recipes for the food product.

The function of utilizing the generator model and the predictor model to select, from the space of possible recipes, the first group of candidate recipes for the food product may take any of various forms, and in at least some implementations, this function may involve (1) utilizing the generator model to train a first iteration of the underlying predictive model based on the second subset of the configuration parameters and the second set of training data, (2) utilizing the generator model to select a first candidate recipe from the space of possible recipes based on a balancing between the predicted values and the uncertainty estimates output by the first iteration of the underlying predictive model and the set of the constraints, (3) utilizing the predictor model to determine a predicted value of the at least one target variable for the first candidate recipe, (4) utilizing the predicted value of the at least one target variable for the first candidate recipe to update the second set of training data, (5) utilizing the generator model to train a second iteration of the underlying predictive model based on the second subset of the configuration parameters and the updated second set of training data, and (6) utilizing the generator model to select a second candidate recipe from the space of possible recipes based on a balancing between the predicted values and the uncertainty estimates output by the second iteration of the underlying predictive model and the set of the constraints.

The configuration parameters may take also take any of various forms.

For instance, the set of assessment variables that are to be evaluated during testing of the candidate recipes may include one or both of (i) a set of sensory attributes that are to be evaluated during testing of the candidate recipes or (ii) a set of measurements that are to be evaluated during testing of the candidate recipes, among other possibilities.

Further, the set of constraints may take any of various forms. For example, the set of constraints may include, for each respective ingredient in the set of ingredients, a respective constraint on an amount of the respective ingredient. As another example, the set of constraints may include a constraint on a combined amount of multiple ingredients within a given ingredient category. As yet another example, the set of constraints may include a constraint on (i) a cost of the candidate recipes, (ii) a nutrition attribute of the candidate recipes, or (iii) a sustainability attribute of the candidate recipes. Other examples are possible as well.

Further yet, the at least one target variable comprises at least one of (i) a variable indicating consumer enjoyment of the food product, (ii) variable indicating cost of the food product, or (iii) a variable indicating environmental impact of the food product.

Still further, the configuration parameters may include a set of process parameters to include in the candidate recipes.

Likewise, the first and second sets of training data may take any of various forms, and in at least some implementations, may include assessment data that has been collected for previously defined recipes.

In some example embodiments, the method may also further involve (a) receiving assessment data for the first group of candidate recipes, wherein the assessment data indicates feedback on the set of assessment variables and (b) storing the assessment data for the first group of candidate recipes.

In another aspect, disclosed herein is a computing platform that includes at least one network interface, at least one processor, at least one non-transitory computer-readable medium, and program instructions stored on the at least one non-transitory computer-readable medium that are executable by the at least one processor such that the computing platform is configured to carry out the functions disclosed herein, including but not limited to the functions of the foregoing method.

In yet another aspect, disclosed herein is a non-transitory computer-readable medium comprising program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts one illustrative example of a computing environment in which the disclosed “artificial intelligence product development” (“AIPD”) software tool may be implemented.

FIG. 2 depicts one possible implementation of functionality that may be provided by the disclosed AIPD software tool in order to enable configuration parameters for a recipe prediction project to be defined.

FIG. 3A illustrates a first example graphical user interface (GUI) view comprising input elements that enable a user to input identifying information, a target goal, and sensory attributes for a recipe prediction project.

FIG. 3B illustrates a second GUI view comprising input elements that enable a user to select ingredients for the recipe prediction project and input constraints on the amounts of the individual ingredients that are selected.

FIG. 3C illustrates an example GUI view comprising input elements that enable a user to select process parameters for the recipe prediction project and input constraints on the values of the process parameters that are selected.

FIG. 3D illustrates an example GUI view that comprising input elements that enable a user to select measurements and upload assessment data for the recipe prediction product.

FIG. 4 depicts a conceptual illustration of one possible implementation of artificial intelligence that is applied by the disclosed AIPD tool.

FIG. 5A depicts an illustration of an underlying predictive model that could be trained by a generator model in accordance with one simplified example of the present disclosure.

FIG. 5B illustrates a re-trained version of the example underlying predictive model of FIG. 5A that has been re-trained based on a predicted value of the target variable for a previously selected candidate recipe that was output by an example predictor model.

FIG. 6 depicts one possible implementation of functionality that may be provided by the disclosed AIPD software tool in order to generate a first group of candidate recipes for the recipe prediction project.

FIG. 7A provides one example of a GUI view through which a user can view the first group of candidate recipes.

FIG. 7B provides another example of a GUI view that displays a candidate recipe.

FIG. 8 depicts one possible implementation of functionality that may be provided by the disclosed AIPD software tool in order to collect assessment data for test samples that were prepared and evaluated as part of the recipe prediction project.

FIG. 9A illustrates a first portion of an example GUI view for inputting feedback.

FIG. 9B illustrates a second portion of an example GUI view for inputting feedback.

FIG. 9C illustrates a third portion of an example GUI view for inputting feedback.

FIG. 9D illustrates a fourth portion of an example GUI view for inputting feedback.

FIG. 9E illustrates a fifth portion of an example GUI view for inputting feedback.

FIG. 10 is simplified block diagram illustrating some structural components that may be included in an example computing platform that may be configured to perform some or all of the server-side functions disclosed herein.

FIG. 11 is a simplified block diagram illustrating some structural components that may be included in an example client device that may be configured to perform some or all of the client-side functions disclosed herein.

### DETAILED DESCRIPTION

As noted above, developing a food product that is to be sold commercially (e.g., snack products, canned food products, candy and gum products, soft drink products, etc.) can be a complex, time consuming, and costly endeavor that requires balancing of a wide range of different factors, and due to the practical constraints on a human's creativity, knowledge, and ability to balance multiple different factors that can each have a range of acceptable values, there is often a universe of other recipe options for the food product that are never even considered or explored, which may lead to sub-optimal results. As such, there is a need for technology that can help improve the process of developing a food product that is to be sold commercially so that it is not limited by these practical constraints on human creativity, knowledge, and abilities but still leverages the real-world experience and expertise of product developers as well as real-world feedback about the recipe options that are being considered for the food product.

In this respect, there is some existing technology that utilizes artificial intelligence to generate recipes for a food item. For instance, there is existing technology that utilizes machine learning techniques to determine an optimum recipe or set of recipes for a given set of recipe constraints, as well as existing technology that utilizes machine learning techniques to generate a recipe for an alternative food item that mimics a target food item using different source ingredients (e.g., plant-based ingredients rather than source ingredients). There is other existing technology that utilizes artificial intelligence to generate recipes for a food item as well.

However, due to various limitations and drawbacks of the existing technology that utilizes artificial intelligence to generate recipes for a food item, that technology does not satisfy the needs described herein. For instance, much of the existing technology for generating recipes for a food item is designed with a focus on generating personalized recipes for food items that are to be prepared at home, and as a result, that technology is not capable of balancing the same kinds of factors or exploring the same kinds of recipe options that need to be balanced and explored when developing a food product that is to be sold commercially, nor is that technology capable of leveraging the real-world experience and expertise of product developers or real-world feedback about recipe options. Moreover, because the existing technology for generating a recipe that mimics a target food item is designed to accomplish on one specific goal (i.e., finding a recipe for an alternative food item that mimics a target food item using different source ingredients), that technology suffers from similar deficiencies—in particular, it is not capable of balancing the same kinds of factors or exploring the same kinds of recipe options that need to be balanced and explored when developing food products that are to be sold commercially, nor is it capable of leveraging the real-world experience and expertise of product developers or real-world feedback about recipe options in the same ways contemplated herein. These limitations and drawbacks of the existing technology are merely exemplary, and there are also other technical problems with the existing technology for generating recipes that make it difficult or impossible to use that existing technology to assist in the process of developing food products that are to be sold commercially.

To address these and other problems with the existing technology that utilizes artificial intelligence to generate recipes for a food item, disclosed herein is a new software tool for predicting, evaluating, and managing candidate recipes for a food product, which may be referred to as an “artificial intelligence product development” (“AIPD”) software tool. As used herein, the term “recipe” may refer to dataset that includes a specified set of ingredients having specified amounts and may also optionally include a specified set of process parameters having specified values. In practice, the disclosed AIPD tool may take the form of a software application that is hosted on a back-end computing platform of an organization involved in the development of food products and is accessible by client devices over a communication path that typically includes the Internet (among other data networks that may be included). In this respect, the disclosed AIPD software tool may comprise server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the AIPD tool could take other forms and/or be implemented in other manners as well.

At a high level, the disclosed AIPD tool may include functionality for (i) setting up a new recipe prediction project for a given food product, which may involve defining configuration parameters for the recipe prediction project based on input from a user such as a product developer, (ii) predicting an initial group of candidate recipes for the recipe prediction project by carrying out an initial “run” of the disclosed artificial intelligence technology, (iii) collecting assessment data for the initial group of candidate recipes by providing evaluators (e.g., taste testers, laboratory technicians, etc.) with an interface for inputting feedback about test samples that were produced using the candidate recipes, (iv) predicting one or more supplemental groups of candidate recipes by carrying out one or more subsequent runs of the disclosed artificial intelligence technology that are informed by the assessment data collected during the previous run(s) of the disclosed artificial intelligence technology, and (v) collecting assessment data for each supplemental group of candidate recipes via the interface for inputting feedback about test samples that were produced using the candidate recipes, among other functionality that is provided by the disclosed AIPD software tool in order to enable users to predict, evaluate, and manage candidate recipes for a food product. In this way, the disclosed AIPID software tool augments the task of developing a food product that is to be sold commercially in ways that overcome the practical constraints on human creativity, knowledge, and abilities while still leveraging the real-world experience and expertise of product developers as well as real-world feedback about the candidate recipes for the food product. The functionality of the disclosed AIPD software tool is described in further detail below.

The disclosed AIPD software tool may provide various advantages over the existing technology for generating recipes for food items utilizing artificial intelligence. For instance, unlike the existing technology, the disclosed AIPD software tool uses artificial intelligence that is capable of predicting candidate recipes for achieving any of various user-specified target goals by virtue of generating and exploring a space of possible recipes along with corresponding scores indicating an extent to which the recipes in the space are expected to achieve a user-specified target goal. Additionally, the disclosed AIPD software tool leverages a combination of configuration parameters specified by product developers, artificial intelligence, and real-world feedback in order to predict candidate recipes, which leads to more useful recipe predictions. Additionally yet, the disclosed AIPD software tool provides a guided, iterative workflow for predicting and evaluating candidate recipes that allows a recipe prediction project to be carried out in a more efficient and user-friendly manner. The disclosed AIPD software tool also provides other advantages over the existing technology, which are apparent from the more detailed discussion of the AIPD software tool that follows.

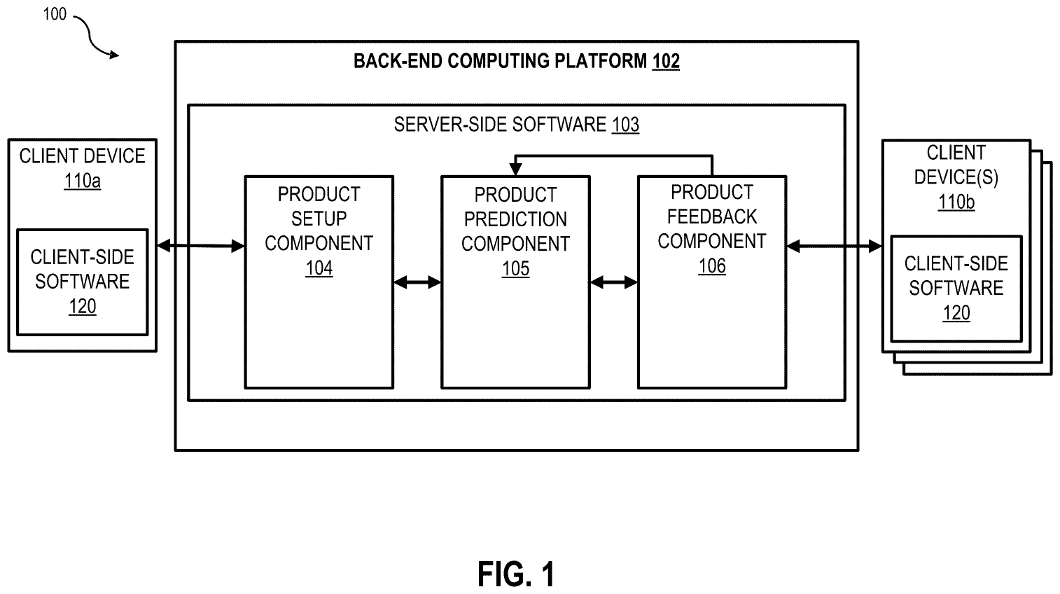

Turning now to the figures, FIG. 1 depicts one illustrative example of a computing environment 100 in which the disclosed AIPD software tool may be implemented. As shown, the example computing environment 100 may include a back-end computing platform 102 and a plurality of client devices 110, of which client devices 110a and 110b are shown as examples.

The back-end computing platform 102 may comprise any one or more computer systems (e.g., one or more servers) that have been installed with server-side software 103 of the disclosed AIPD software tool, which may configure the back-end computing platform 102 to carry out the server-side functionality disclosed herein. For purposes of illustration and discussion, server-side software 103 as shown as including a product setup component 104, a product prediction component 105, and a product feedback component 106, but it should be understood that server-side software 103 could take various other forms as well.

In practice, the one or more computer systems of back-end computing platform 102 may collectively comprise some set of physical computing resources (e.g., one or more processors, data storage system, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the log management platform 204 may comprise “on-premises” computing resources of the given software provider (e.g., servers owned by the given software provider). As yet another possibility, the back-end computing platform 102 may comprise a combination of cloud computing resources and on-premises computing resources. Other implementations of the back-end computing platform 102 are possible as well.

Further, in practice, the server-side software 103 of the disclosed AIPD software tool may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, server-side software 103 for the disclosed AIPD software tool may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The example back-end computing platform 102 may comprise various other components and take various other forms as well.

Turning to the client devices 110, in general, each of example client devices 110a, 110b may take the form of any computing device that is capable of running client-side software 120 of the disclosed AIPD software tool, which as noted above may take the form of a client application that runs in a web browser, a native desktop application, or a mobile application, among other possibilities. In this respect, each of example client devices 110a, 110b may include hardware components such as one or more processors, data storage, communication interfaces, and input/output (I/O) components (or interfaces for connecting thereto), among other possible hardware components, as well as software components such as operating system (OS) software, web browser software, and/or the client-side software 120 of the disclosed AIPD software tool, among other possible software components. As representative examples, each of example client devices 110a, 110b may take the form of a desktop computer, a laptop, a netbook, a tablet, a smartphone, or a personal digital assistant (PDA), among other possibilities.

As further depicted in FIG. 1, each of example client devices 110a, 110b may be configured to communicate with the back-end computing platform 102 over a respective communication path. Each of these communication paths may generally comprise one or more data networks and/or data links, which may take any of various forms. For instance, each respective communication path between an example client device 110a, 110b and the back-end computing platform 102 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between an example client device 110a, 110b and the back-end computing platform 102 may be carried out via an Application Programming Interface (API) provided by the back-end computing platform 102, among other possibilities. Although not shown, the respective communication paths between the example client devices 110a, 110b and the back-end computing platform 102 may also include one or more intermediate systems, examples of which may include a data aggregation system and host server, among other possibilities. Many other configurations are also possible.

It should be understood that computing environment 100 is one example of a computing environment in which the disclosed software technology may be implemented, and that numerous other examples of computing environments are possible as well.

The functionality of the server-side software 103 and client-side software 120 of the disclosed AIPD software tool will be now described in further detail.

To begin, at a high level, the example product setup component 104 of the server-side software 103 may cause the back-end computing platform 102 to carry out functionality for setting up a new recipe prediction project for a given food product, which may involve defining configuration parameters for the recipe prediction project (among other possible setup tasks). These configuration parameters may include any of various different types of parameters that may be utilized by the server-side software 103 during the course of the recipe prediction project, including but not limited to parameters that are used during the process of predicting the candidate recipes for the given food product.

One category of configuration parameters that may be defined for the recipe prediction project may comprise identifying information for the recipe prediction project and/or the given food product for which the candidate recipes are to be predicted. Such identifying information may take any of various forms, examples of which may include a name and/or type of the recipe prediction project, a name and/or type of the given food product for which the candidate recipes are to be predicted, and/or a location where the given food product is expected to be sold, among various other examples of identifying information that may be defined for the recipe prediction project.

Another category of configuration parameters that may be defined for the recipe prediction project may comprise a target goal for the candidate recipes, which may comprise a particular goal that the user wishes to achieve with the candidate recipes that are predicted as part of the recipe prediction project. The target goal that is defined for the candidate recipes may take any of various forms.

As one possibility, the target goal for the candidate recipes may be to improve consumer enjoyment of the given food product, which may be represented in terms of a single variable that indicates the consumer enjoyment achieved by a candidate recipe (e.g., a variable called “overall_liking”) or a set of multiple variables that collectively indicate the consumer enjoyment achieved by a candidate recipe.

As another possibility, the target goal for the candidate recipes may be to reduce cost of the given food product, which may be represented in terms of a single variable that indicates the cost reduction achieved by a candidate recipe (e.g., a variable called “cost_reduction”) or a set of multiple variables that collectively indicate the cost reduction achieved by a candidate recipe.

As yet another possibility, the target goal for the candidate recipes may be to reduce the environmental impact of the given food product (e.g., the carbon footprint), which may be represented in terms of a single variable that indicates the environmental-impact reduction achieved by a candidate recipe (e.g., a variable called “environmental_impact_reduction”) or a set of multiple variables that collectively indicate the environmental-impact reduction achieved by a candidate recipe.

As still another possibility, the target goal for the candidate recipes may be to maximize or minimize a particular sensory attribute of the candidate recipes, such as a particular sensory attribute related to appearance, aroma, flavor, texture, aftertaste, or the like, which may be represented in terms of a single variable that indicates the level of the sensory attribute exhibited by a candidate recipe or a set of multiple variables that collectively indicate the level of the sensory attribute exhibited by a candidate recipe.

As a further possibility, the target goal for the candidate recipes may comprise a combination of multiple individual goals, such as a combination of improving consumer enjoyment of the given food product and either reducing cost or reducing environmental impact, among various other possibilities

The target goal that is defined for the candidate recipes may take various other forms as well. Further, in practice, the target goal could either be defined independent of any specific reference point or could be defined relative to some reference point, such as how well the candidate recipes accomplish the target goal as compared to a reference recipe.

Yet another category of configuration parameters that may be defined for the recipe prediction project may comprise a set of ingredients to include in the candidate recipes that are to be predicted. This set of ingredients may take any of various forms, which may depend in part on the type of food product for which the candidate recipes are to be generated. As some representative examples, the set of ingredients may be defined to include ingredients such as sugars (e.g., sucrose mixtures thereof such as granulated sugar, brown sugar, confectioner's sugar, and coconut sugar; other disaccharides such as lactose; monosaccharides such as glucose, galactose, and fructose; polysaccharides such as glycogen and starch; etc.), sweeteners (e.g., saccharin, aspartame, alitame, stevia, sucralose, cyclamate, advantame, neotame, acesulfame potassium, etc.), gums (e.g., xanthan gum, welan gum, gellan gum, diutan gum, pullulan, dextran, etc.), antioxidants (e.g., carotenoids such as lycopene and lutein; flavonoids such as flavanol, anthocyanins, quercetin, and catechins; etc.), flours (e.g., all-purpose flour, semolina flour, bread flour, self-rising flour, whole wheat flour, Barley flour, almond flour, amaranth flour, arrowroot flour, cassava flour, rice flour, millet flour, corn flour, quinoa flour, potato flour, pastry flour, tapioca flour, rye flour, lentil flour, oat flour, durham flour, etc.), oils (e.g., canola oil, olive oil, peanut oil, sesame oil, palm oil, cottonseed oil, sunflower oil, hazelnut oil, rapeseed oil, corn oil, pine nut oil, lemon oil, flaxseed oil, avocado oil, etc.), additives (e.g., food colors, emulsifiers such as polyglycerol esters, soy lecithin, mustard lecithin, carrageenan, and polysorbates; stabilizing agents such as pectin, alginate, and sodium pyrophosphate; nutritional additives such as vitamins, minerals, dietary fiber, and linoleic acid; etc.), preservatives (e.g., antimicrobial agents such as phenol, benzoic acid, sorbic acid, chlorobutanol, and benzalkonium chloride; chelating agents such as citric acid, Ethylenediamine tetraacetic acid, and polyphosphates; etc.), extracts (e.g., fruit extracts such as lemon extract, vanilla extract, orange extract, banana extract; almond extract, rhubarb extract, peppermint extract, rum extract, coconut extract, etc.), spices (e.g., oregano, basil, cumin, turmeric, harissa, curry powder, thyme, garlic powder, bay leaves, anise, caraway, cardamom, cloves, cinnamon, coriander, dill seed, fennel, ginger, nutmeg, black pepper, red pepper, chili powder, saffron, etc.), flavors (e.g., natural flavors such as acetoin, benzaldehyde, geraniol, vanillin, amyl acetate, and massoia lactone; artificial flavors such as sodium benzoate, monosodium glutamate, butylated hydroxytoluene, isosafrole, pulegone, menthofuran, quassin, and methyleugenol; etc.), rising agents (e.g., chemical rising agents such as baking soda and baking power; natural rising agents such as brewer's yeast, baker's yeast, active yeast, and osmotolerant yeast; etc.), bacterial cultures (e.g., bifidobacterium cultures such as Bifidobacterium animalis, Bifidobacterium bifidum, and Bifidobacterium lactis; lactobacillus cultures such as Lactobacillus acidophilus, Lactobacillus rhamnosus, and Lactobacillus casei; other cultures such as Enterococcus faecium and Saccharomyces boulardii; etc.), and concentrates (e.g., juice concentrates, vegetable concentrates, etc.), among various other examples of ingredients that are included in the set of ingredients defined for the recipe prediction project.

Still another category of configuration parameters that may be defined for the recipe prediction project may comprise a set of process parameters for producing food products that are to be included as part of the candidate recipe predictions. Such process parameters may take any of various forms, examples of which may include cooking length, cooking temperature, cooking technique (e.g., frying or baking), mixing technique (e.g., whipping, stirring, kneading, pureeing, etc.), and/or rising duration (e.g., for yeasted breads), among various other examples of process parameters that may be included as part of the candidate recipe predictions.

A further category of configuration parameters that may be defined for the recipe prediction project may comprise a set of constraints to apply when predicting the candidate recipes. This set of constraints may take any of various forms.

As one possibility, the set of constraints that is defined for the recipe prediction project may include a type of constraint that imposes some limit on an amount of an individual ingredient that can be included in a predicted candidate recipe, such as a minimum amount, a maximum amount, a pair of minimum and maximum amounts, or a fixed amount. For instance, a first example of this type of constraint may impose a limit on a minimum amount of a first example ingredient that can be included in a predicted candidate recipe (e.g., a minimum number of grams) while leaving the maximum amount of the first example ingredient unconstrained, a second example of this type of constraint may impose a limit on a maximum amount of a second example ingredient that can be included in a predicted candidate recipe (e.g., a maximum number of grams) while leaving the minimum amount of the second example ingredient unconstrained, a third example of this type of constraint may impose a limit on both a minimum amount and a maximum amount of a third example ingredient that can be included in a predicted candidate recipe (e.g., a minimum and maximum number of grams), and a fourth example of this type of constraint may specify a fixed amount of a fourth example ingredient that is to be included in a predicted candidate recipe (e.g., a fixed number of grams). Other examples are possible as well.

As another possibility, the set of constraints that is defined for the recipe prediction project may include a type of constraint that imposes some limit on a combined amount of multiple ingredients that can be included in a predicted candidate recipe (e.g., ingredients within the same ingredient category). For instance, a first example of this type of constraint may impose a limit on the combined amounts of multiple ingredients within a certain category (e.g., a maximum and/or minimum limit on the combined weight of sweeteners), a second example of this type of constraint may impose a limit on the ratio between ingredients within one category and ingredients within one or more other categories (e.g., a maximum limit on the ratio between the combined weight of sweeteners to the combined weight of the flours), and a third example of this type of constraint may impose a limit on the ratio between the combined weight of ingredients within a certain category and the combined weight of all ingredients included in the candidate recipe (e.g., a maximum limit on the ratio between the combined weight of oils and the combined weight of all ingredients included in the recipe). Other examples are possible as well.

As yet another possibility, the set of constraints that is defined for the recipe prediction project may include a type of constraint that imposes some limit on a factor that is linearly dependent on the ingredient amounts included in the candidate recipes, examples of which may include a measure of cost, a measure of a nutrition attribute (e.g., salt, sugar, sat fat, fiber, etc.), or a measure of a sustainability attribute (e.g., carbon dioxide production, water usage, etc.). For instance, (i) a first example of this type of constraint may impose a limit on the total cost of a candidate recipe (e.g., a maximum cost per unit of a candidate recipe), which may be determined based on the cost-per-unit of each ingredient (e.g., price per gram) and amount of each ingredient included in the candidate recipe, (ii) second example of this type of constraint may impose a limit on a given nutrition attribute, which may be determined based on the amount-per-unit of the nutrition attribute present in each ingredient and the amount of each ingredient included in the candidate recipe, and (iii) third example of this type of constraint may impose a limit on a given sustainability attribute, which may be determined based on the amount-per-unit of the sustainability attribute present in each ingredient and the amount of each ingredient included in the candidate recipe. In each of the foregoing examples, the per-unit values for each ingredient may be specified by a user, hard-coded into the disclosed AIPD software tool, or otherwise determined by the back-end computing platform 102 (e.g., by accessing a cost database), among other possibilities. Further, while the foregoing examples are described in terms of limits for a candidate recipe as a whole, it should be understood that similar constraints may be defined for subsets of ingredients (e.g., a limit on the cost, nutrition, or sustainability of ingredients within a certain category). A constraint that on a factor that is linearly dependent on the ingredient amounts included in the candidate recipes may take various other forms as well.

As still another possibility, the set of constraints that is defined for the recipe prediction project may a type of constraint that imposes some limit on a value of a process parameter that is defined for the candidate recipes, such as a minimum value, a maximum value, a pair of minimum and maximum values, or a fixed value. For instance, a first example of this type of constraint may impose a maximum, minimum, of fixed limit on cooking temperature and a second example of this type of constraint may impose a maximum, minimum, of fixed limit on cooking time. Other examples are possible as well.

The set of constraints that is defined for the recipe prediction project may include various other types of constraints a well. Moreover, in practice, the set of constraints that are defined for the recipe prediction project may include constraints that are specified by the user and perhaps also other constraints that are determined by the back-end computing platform 102 based on an analysis of the user-specified configuration parameters.

Still a further category of configuration parameters that may be defined for the recipe prediction project may comprise a set of sensory attributes that are to be evaluated during testing of the candidate recipes. The set of sensory attributes may include attributes related to the appearance, aroma, flavor, aftertaste, and/or texture of food samples that are produced using the candidate recipes, among other possible types of sensory attributes. As some representative examples, such sensory attributes may include an extent of a particular aspect of the sample's appearance, an overall intensity or liking of the sample's appearance, an extent of a particular kind of aroma, an overall intensity or liking of the sample's aroma, an extent of a particular kind of flavor or aftertaste, an overall intensity or liking of the sample's flavor or aftertaste, an extent of a particular kind of texture, and/or an overall intensity or liking of the sample's texture, among other possibilities. Other examples are possible as well.

Yet another category of configuration parameters that may be defined for the recipe prediction project may comprise a set of measurements that are to be captured by measurement tools during testing of the candidate recipes, which may include measurements of any one or more chemical properties, nutritional properties, physical properties, or safety-related properties of food samples prepared using the candidate recipes. As representative examples, such measurements may include any one or more of a number of calories included in a serving of a food sample prepared using a candidate recipe (e.g., as indicated by a calorimeter), a color of a food sample prepared using a candidate recipe, a pH of a food sample prepared using a candidate recipe, a level of contaminants in a food sample prepared using a candidate recipe, a moisture content of a food sample prepared using a candidate recipe, a physical dimension of a food sample prepared using a candidate recipe, and/or a weight or volume of a food sample prepared using a candidate recipe. Other examples are possible as well.

The configuration parameters for the recipe prediction project may take various other forms as well. Further, it should be understood that the configuration parameters that are defined for the recipe prediction project may include some categories of configuration parameters but not others (i.e., at least some of the foregoing categories of configuration parameters may be considered optional). For instance, the configuration parameters for a recipe prediction project might include a set of ingredients, a target goal, a set of constraints, and a set of sensory attributes to be evaluated, but may not include any defined processor parameters or measurements. Many other examples are possible as well.

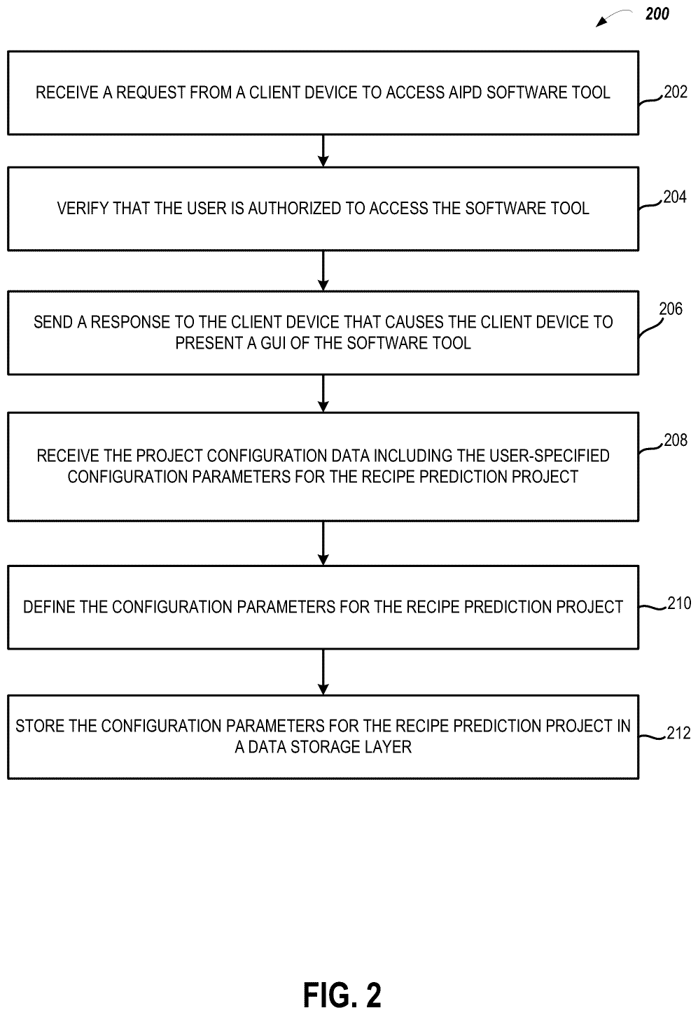

The functionality that is provided by the product setup component 104 of the server-side software 103 in order to enable configuration parameters for a recipe prediction project to be defined may also take various forms, and one possible implementation of that functionality is illustrated in FIG. 2. For purposes of illustration, the example functionality 200 of FIG. 2 is described as being carried out by the back-end computing platform 102 of FIG. 1, but it should be understood that the example functionality of FIG. 2 may be carried out by any computing platform that is capable of running the software disclosed herein. Further, it should be understood that the example functionality of FIG. 2 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 2, the example functionality 200 may begin at block 202 with the back-end computing platform 102 receiving a request from a client device 110, such as example client device 110a, to access an instance of the disclosed AIPD software tool. In practice, this request may take the form of one or more request messages (e.g., one or more HTTP messages) that are sent over the respective communication path between the client device 110a and the back-end computing platform 102 (which as noted above may include at least one data network), and in at least some implementations, the one or more request messages may be sent via an API. Further, the request that is received from the client device 110a may include identifying information and/or security credentials (e.g., a username and password, a security token, etc.) for the user, among other possible information that may be included in the request. The request to access the AIPD software tool may take other forms and/or be received in other manners as well.

At block 204, after receiving the request access the AIPD software tool, the back-end computing platform 102 may optionally verify that the user has authorization to access the AIPD software tool, which may be carried out using any authentication and/or authorization technology now known or later developed.

At block 206, after receiving the request to access the AIPD software tool and optionally verifying that the has authorization to access the AIPD software tool, the back-end computing platform 102 may send a response to the client device 110a that enables and causes the client device 110a to run client-side software for the AIPD software tool. In practice, this request may take the form of one or more response messages (e.g., one or more HTTP messages) that are sent over the respective communication path between the back-end computing platform 102 and the client device 110a (which as noted above may include at least one data network), and in at least some implementations, the one or more response messages may be sent via an API. Further, the response that is sent to the client device 110a may comprise instructions and data for presenting a graphical user interface (GUI) of the AIPD software tool to the user, which the client device 110a may utilize to present the GUI of the AIPD software tool to the user.

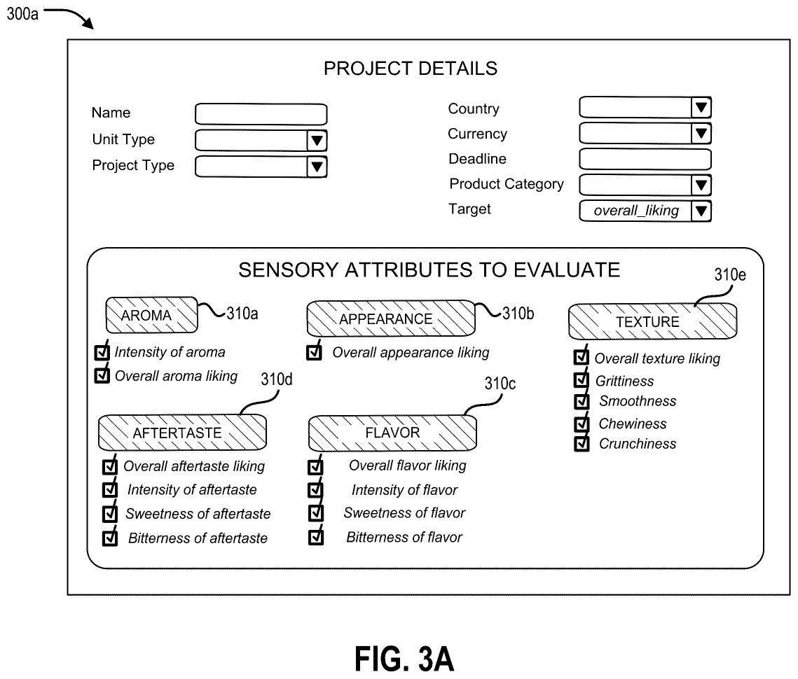

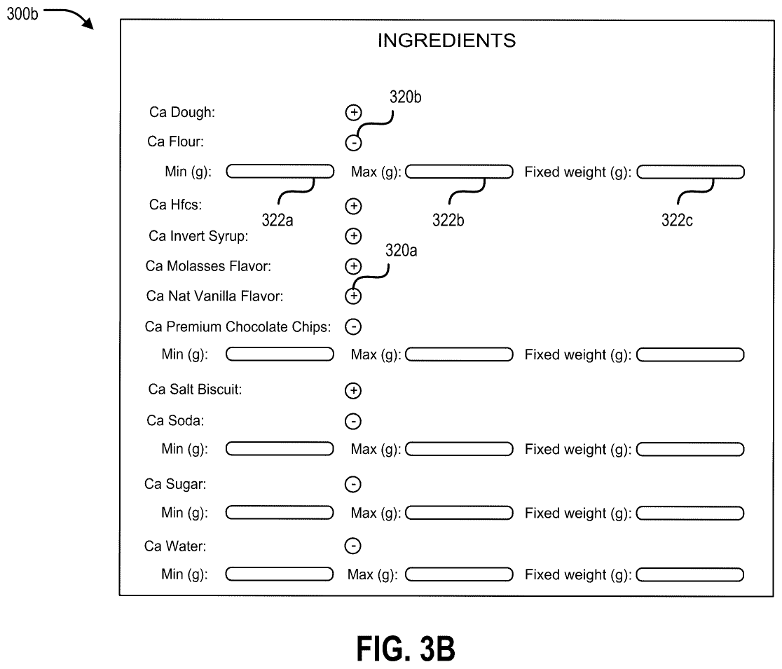

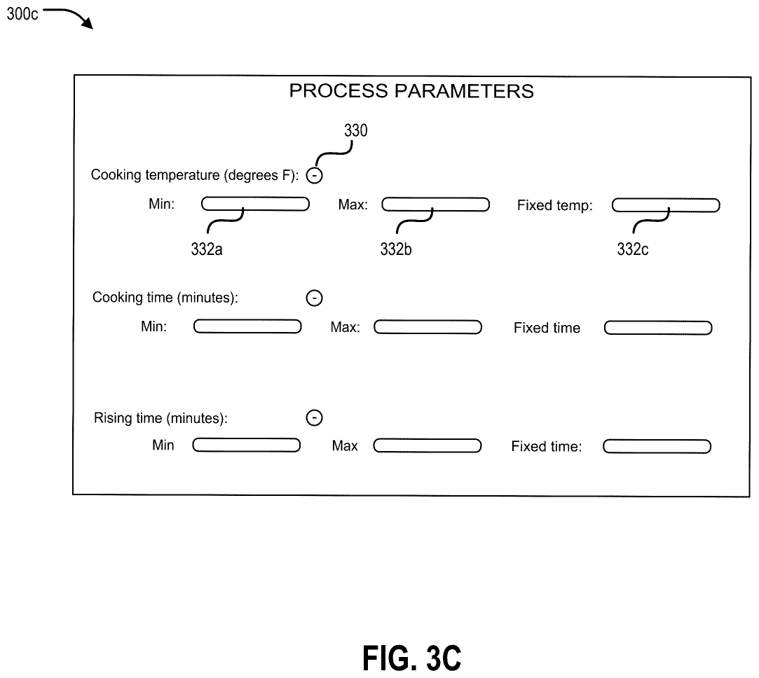

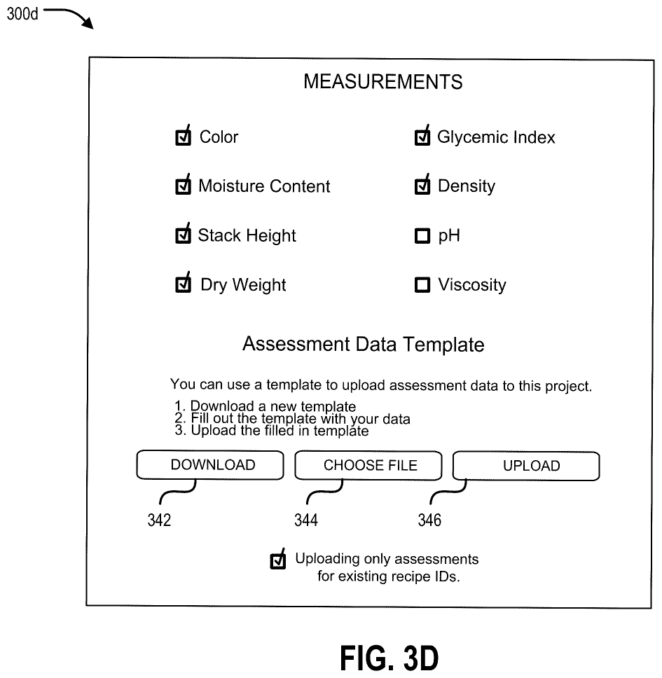

In accordance with the present disclosure, the GUI of the AIPD software tool that is presented by the client device 110a may include various GUI input elements (e.g., buttons, text fields, dropdown lists, slider bars, etc.) that enable the user to initiate a new recipe prediction project and specify certain configuration parameters for the new recipe prediction project. For instance, in line with the discussion above, the GUI of the AIPD software tool that is presented by the client device 110a may include GUI input elements that enable the user to provide user input for specifying any one or more of (i) identifying information for the recipe prediction project and/or the given food product for which the candidate recipes are to be predicted, (ii) a target goal for the candidate recipes, (iii) a set of ingredients to include in the candidate recipes, (iv) a set of process parameters that are to be defined as part of the candidate recipes and utilized when producing food products in accordance with the candidate recipes, (v) a set of constraints to apply when predicting the candidate recipes, (vi) a set of sensory attributes that are to be evaluated during testing of the candidate recipes, and/or (vii) a set of a measurements that are to be captured during testing of the candidate recipes, among other possible examples of configuration parameters that may be specified for the recipe prediction project. Some representative examples of GUI elements and user input that may be utilized to specify the configuration parameters for the recipe prediction project are described in further detail below with reference to FIGS. 3A-3D.

After client device 110a presents the GUI of the AIPD software tool, the user may utilize the GUI of the AIPD software tool to provide user input that specifies certain configuration parameters for the recipe prediction project. In turn, the client device 110a may send project configuration data indicating the user-specified configuration parameters for the recipe prediction project to the back-end computing platform 102, and at block 208, the back-end computing platform 102 may receive the project configuration data indicating the user-specified configuration parameters for the recipe prediction project. In practice, this project configuration data may be contained within one or more request messages (e.g., one or more HTTP messages) that are sent over the respective communication path between the client device 110a and the back-end computing platform 102 (which as noted above may include at least one data network), and in at least some implementations, the one or more request messages may be sent via an API. For instance, in some implementations, the full set of project configuration data may be contained within a single request message, whereas in other implementations, the project configuration data may be divided across multiple request messages. Further, the project configuration data indicating the user-specified configuration parameters for the recipe prediction project could include the actual values of the user-specified configuration parameters (e.g., a listing of ingredients, a listing of constraints, etc.) and/or could include other indications of the user-specified configuration parameters, such as an indicator that maps to a predefined package of configuration parameters (e.g., an indicator of a particular type of food product that maps to a predefined set of ingredients and can be utilized by the back-end computing platform 102 to access the predefined set of ingredients). The project configuration data may take other forms and/or be received in other manners as well.

At block 210, based on the project configuration data, the back-end computing platform 102 may define the configuration parameters for the new recipe prediction project. This function may take various forms, which may depend in part on the form of the project configuration data.

As one possibility, if the project configuration data includes the actual value of a given configuration parameter, the back-end computing platform 102 may define the given configuration parameter to have the value specified within the project configuration data. As another possibility, if the project configuration data includes some other indication of a configuration parameter, the back-end computing platform 102 may use the indicator to determine the value of the given configuration parameter (e.g., by performing a database lookup) and then define the given configuration parameter to have the determined value. As yet another possibility, if a given configuration parameter was not specified by the user but is nevertheless deemed to be a necessary configuration parameter for the recipe prediction project, the back-end computing platform 102 may determine a value for the given configuration parameter and then define the given configuration parameter to have the determined value. For example, if the user specifies that a given ingredient is to be included in the candidate recipes but does not specify any constraints on the amount of the given ingredient, the back-end computing platform 102 may determine an appropriate limit on the amount of the given ingredient to be included in the candidate recipes (e.g., a min amount, max amount, min/max amount, or fixed amount) and then use that determined limit to define an individual-ingredient constraint for the given ingredient that is added to the configuration parameters for the recipe prediction project. The function of defining the configuration parameters for the new recipe prediction project may take other forms as well.

At block 212, after defining the configuration parameters for the new recipe prediction project, the back-end computing platform 102 may then store the configuration parameters for the new recipe prediction project in a data storage layer of the platform (e.g., in a relational database) so that such configuration parameters can then be accessed by other components of the server-side software 103.

The functionality that is provided by the product setup component 104 of the server-side software 103 in order to enable configuration parameters for a recipe prediction project to be defined may take various other forms as well.

Along with defining configuration parameters for a recipe prediction project, the product setup component 104 of the server-side software 103 may also optionally enable a user to input other data that can be utilized during the process of predicting the candidate recipes. For example, in some implementations, the product setup component 104 of the server-side software 103 may also enable a user to upload a set of assessment data for previously defined recipes, which can be utilized by the product prediction component 105 during the process of predicting the candidate recipes. This assessment data may include historical assessment data that was captured during prior real-world testing of previously defined recipes and/or synthetic assessment data for previously defined recipes that was created independent of any real-world testing of recipes, among other possibilities. Other examples are possible as well.

Further, in some implementations, the product setup component 104 of the server-side software 103 may enable a user to initiate a new recipe prediction project by copying the configuration parameters of a previous recipe prediction project and then modifying any of the configuration parameters as desired in order to create the new recipe prediction project, which may be considered to be an updated version of the recipe prediction project.

Turning now to FIGS. 3A-3D, some example GUI views for setting up a new recipe prediction project in accordance with the present disclosure are illustrated. For instance, FIG. 3A illustrates a first example GUI view 300a comprising input elements that enable a user to input identifying information, a target goal, and sensory attributes for a recipe prediction project.

As shown, the GUI view 300a may include a set of input elements (e.g., fillable text fields, dropdown lists, etc.) that enable the user to input identifying information for the recipe prediction project, such as a name, a country, a project type, a unit type, a currency, a deadline, and a product category for the recipe prediction project. Further, as shown, the GUI view 300a may include an input element that enables the user to input a target goal, such as by specifying a target variable that is to be optimized, which in this example is an “overall_liking” variable that indicates an extent of consumer enjoyment achieved by a candidate recipe. Further yet, as shown, the GUI view 300a may include a set of selectable buttons that enable the user to select sensory attributes that are to be evaluated for the recipe prediction project, which may be broken down into different categories of sensory attributes such as aroma 310a, appearance 310b, flavor 310c, aftertaste 310d, and texture 310e. It is also contemplated that the user could scroll downward in the GUI view 300a to view any additional sensory attributes that are available for selection. The GUI view that allows a user to enter identifying information, a target goal, and sensory attributes for a recipe prediction project may take a variety of other forms.

FIG. 3B illustrates a second GUI view 300b comprising input elements that enable a user to select ingredients for the recipe prediction project and input constraints on the amounts of the individual ingredients that are selected. For instance, as shown, the example GUI view 300b displays a list of process ingredient options that is each associated with a selectable button that allows a user to select the ingredient. For example, the button 320a maps to the ingredient entitled “ca nat vanilla flavor” and the button 320b maps to the ingredient entitled “ca flour.” A plus symbol is displayed on the button 320a because that ingredient has not been selected by the user, and as a result, the fields for specifying constraints on the amount of “ca nat vanilla flavor” are currently hidden. On the other hand, a minus symbol is displayed on the button 320b because that ingredient has been selected by the user, and as a result, the fields for specifying constraints on the amount of “ca flour” are displayed. Specifically, as shown, GUI view 300b includes fields that allow a user to specify any of a minimum amount for “ca flour” by entering a value into the field 322a, a maximum amount for “ca flour” by entering a value into the field 322b, or a fixed amount of “ca flour” by entering a value into the field 322c. The GUI view that allows a user to select the ingredients for the recipe prediction project and input constraints on the amounts of the individual ingredients that are selected may take a variety of other forms.

FIG. 3C illustrates an example GUI view 300c comprising input elements that enable a user to select process parameters for the recipe prediction project and input constraints on the values of the process parameters that are selected. For instance, as shown, the example GUI view 300c displays a list of process parameter options that is each associated with a selectable button that allows a user to select the process parameter. For example, a minus symbol is displayed on the button 330 because that process parameter has been selected by the user, and as a result, the fields for specifying constraints on the value of the “Cooking temperature” parameter are displayed. Specifically, as shown, GUI view 300c includes fields that allow a user to specify any of a minimum value for the “Cooking temperature” parameter by entering a value into the field 332a, a maximum value for the “Cooking temperature” parameter by entering a value into the field 332b, or a fixed value for the “Cooking temperature” parameter by entering a value into the field 332c. The GUI view that allows a user to select process parameters for the recipe prediction project and input constraints on the amounts of the process parameters that are selected may take a variety of other forms.

FIG. 3D illustrates an example GUI view 300d that comprising input elements that enable a user to select measurements and upload assessment data for the recipe prediction product. For instance, as shown, the example GUI view 300d displays a list of measurement options 340 that is each associated with a selectable check box that allows a user to select the measurement. Additionally, as shown, the example GUI view 300d includes a selectable button 342 that enables a user to download a template that can then be used to create a file containing assessment data for the recipe prediction project, as well as selectable buttons 344 and 346 for selecting and uploading a file containing assessment data for previously defined recipes. The GUI view that allows a user to select measurements for the recipe prediction project and/or upload assessment data for the recipe prediction project may take a variety of other forms.

Referring back to FIG. 1, at a high level, the product prediction component 105 of the server-side software 103 may cause the back-end computing platform 102 to carry out functionality for predicting candidate recipes for a recipe prediction project that has been set up for a given food product.

In operation, the product prediction component 105 may predict the candidate recipes by applying artificial intelligence to the configuration parameters for the recipe prediction project and available assessment data for other comparable recipes. The artificial intelligence that is applied by the product prediction component 105 may take various forms, and in at least some embodiments, may take the form of one or more data science models that are configured to predict candidate recipes for the recipe prediction project.

For instance, according to one possible embodiment, the artificial intelligence that is applied by the product prediction component 105 may take the form of a generator model and a predictor model (sometimes referred to as a “discriminator model”) and that are used in combination to predict candidate recipes. The generator model may be configured to iteratively (i) train an underlying predictive model that functions to output predicted values of at least one variable related to the recipe prediction project's target goal (which may be referred to herein as a “target variable”) along with uncertainty estimates for a space of possible recipes and (ii) select a candidate recipe from the space of possible recipes based on an analysis of the predicted values of the target variable (sometimes referred to as “scores”) and uncertainty estimates output by the underlying predictive model. In turn, the predictor model may comprise a predictive model that is trained to output, for a given candidate recipe that is passed as input to the predictive model, (i) a predicted value of at least one target variable, (ii) predicted values of a given set of assessment variables (e.g., sensory attributes and/or measurements) that are used during training of the predictor model, and perhaps also (iii) uncertainty estimates for the predicted value of the at least one target variable. In this respect, the predictor model may be used to determine predicted target values for candidate recipes that are selected by the generator model, which may then be used by the generator model as training data during subsequent iterations of training its underlying predictive model.

In this embodiment, during each “run” of the disclosed artificial intelligence technology, the process may begin with the training of the predictor model. Next, the generator model may carry out a first iteration of its functionality, which involves (i) training its underlying predictive model based on an initial training dataset and then (ii) selecting a first candidate recipe from the space of possible recipes based on an analysis of the predicted values of the target variable and the uncertainty estimates output by the underlying predictive model that was trained. After the generator model completes the first iteration of its functionality, that first candidate recipe may be passed as input into the trained predictor model, which may output a predicted value of the at least one target variable (along with predicted values of a given set of assessment variables) for the first candidate recipe. In turn, the generator model may carry out a second iteration of its functionality, which involves (i) re-training its underlying predictive model based on an updated training dataset that includes the predicted value of the at least one target variable for the first candidate recipe and then (ii) selecting a second candidate recipe from the space of possible recipes based on an analysis of the predicted values of the target variable and the uncertainty estimates output by the underlying predictive model that was re-trained. Thereafter, the steps of using the predictor model to output a predicted target value for the previously selected candidate recipe and then carrying out another iteration of the generator model's functionality using the predictor model's predicted target value for the previously selected candidate recipe as training data may be repeated one or more additional times in order to select one or more additional candidate recipes. The process for using the generator and predictor models to predict the candidate recipes could take various other forms as well.

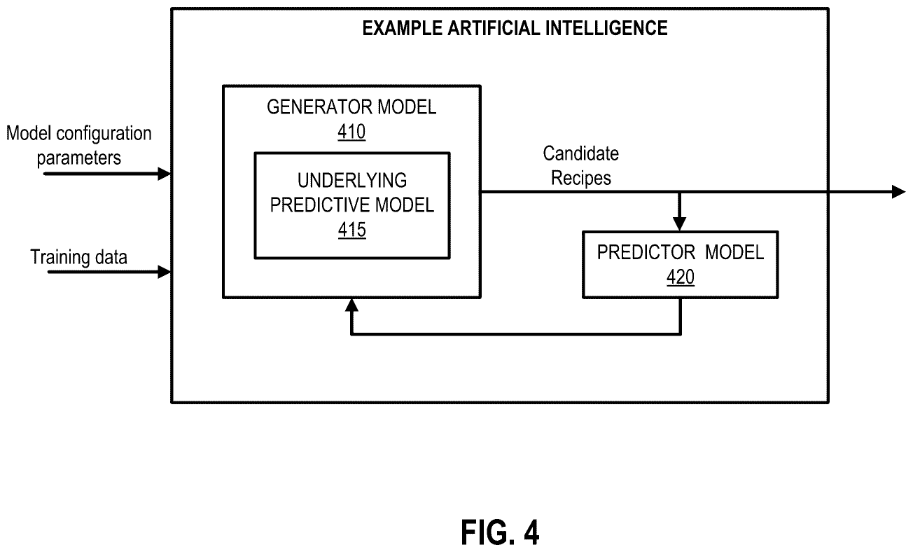

FIG. 4 depicts a conceptual illustration of this particular implementation of the artificial intelligence that is applied by the product prediction component 105, which includes (i) a generator model 410 that trains an underlying predictive model 415 and (ii) a predictor model 420.

At a high level, the underlying predictive model 415 trained by the generator model 410 may comprise any type of predictive model (or sometimes referred to as a “predictive function”) that is trained to output (i) predicted values of at least one target variable (sometimes referred to as “scores”) for a space of possible recipes such that each predicted value indicates an extent to which a respective recipe in the space is expected to achieve the target goal and (ii) uncertainty estimates for the predicted values (among other possible outputs).

In operation, the generator model 410 may train the underlying predictive model 415 by carrying out a machine learning process using (i) a set of model configuration parameters for the underlying predictive model 415 and (ii) a set of training data for the underlying predictive model 415. The set of model configuration parameters for the underlying predictive model 415 may include (i) the independent variables for the underlying predictive model 415, which are the set of ingredients and/or process parameters that make up the recipes, and (ii) the dependent variable(s) for the underlying predictive model 415, which includes the at least one target variable. In this respect, the set of model configuration parameters may be defined based on certain of the project configuration parameters for the recipe prediction project, including but not limited to the set of ingredients, the set of process parameters, and the target goal defined for the recipe prediction project—although it is possible the model configuration parameters for the underlying predictive model 415 may also include additional parameters as well (e.g., model configuration parameters that are defined globally rather than on a project-by-project basis). The model configuration parameters for the underlying predictive model 415 may take other forms as well.

In turn, the set of training data for the underlying predictive model 415 may generally comprise a set of training data records that each includes (i) values for at least a subset of the independent variables for the underlying predictive model 415, such as the ingredients and/or process parameters for the recipe prediction project, and (ii) values for at least a subset of the dependent variables for the underlying predictive model 415, such as the at least one target variable.

Further, the set of training data for the underlying predictive model 415 may include training data records that are obtained from any of various sources. For instance, as one possibility, the set of training data for the underlying predictive model 415 may include training data records that are sourced from a data repository containing assessment data that was collected for other recipe prediction projects, which is sometimes referred to as historical assessment data. More particularly, as assessment data (e.g., values for a target variable, a set of sensory attributes, and/or a set measurements) is collected for candidate recipes during the course of other recipe prediction projects, the back-end computing platform 102 may store such assessment data into a data repository that may then serve as a future source of training data for recipe prediction projects. In this respect, the back-end computing platform 102 may include functionality for evaluating the stored assessment data that was collected for other recipe prediction projects in order to identify data records comprising assessment data for comparable recipes to the candidate recipes that are to be predicted during the current recipe prediction project, such as data records for recipes that were for food products from a similar product category, were made up of similar ingredients and/or process parameters, had a similar target goal, and/or were assessed according to similar sensory attributes and/or measurements. Additionally, in a scenario where the data records for the comparable recipes do not contain values for the entire set of independent and dependent variables for the underlying predictive model 415 (e.g., the entire set of ingredients and/or process parameters and the target variable(s)), the back-end computing platform 102 may modify the data records to include a synthetic value for any variable that is missing, such as by using interpolation to calculate the value or by inserting a predefined value (e.g., 0) for the variable.

As another possibility, the set of training data for the underlying predictive model 415 may include training data records that are sourced from a set of assessment data that was uploaded by a user as part of setting up the recipe prediction project, which may include assessment data that was captured during prior real-world testing of recipes (sometimes referred to as historical assessment data) and/or synthetic assessment data that was created independent of any real-world testing of recipes. In this respect, the back-end computing platform 102 may include functionality for evaluating the set of assessment data uploaded by the user in order to identify data records comprising assessment data for comparable recipes to the candidate recipes that are to be predicted during the current recipe prediction project, such as data records for recipes that were for food products from a similar product category, were made up of similar ingredients and/or process parameters, had a similar target goal, and/or were assessed according to similar sensory attributes and/or measurements. However, in other implementations, the back-end computing platform 102 may be configured to assume that assessment data uploaded by a user as part of setting up the recipe prediction project is comparable and forgo the step of evaluating such assessment data to identify data records for comparable recipes. Additionally, in a scenario where the data records uploaded by the user do not contain values for the entire set of independent and dependent variables for the underlying predictive model 415 (e.g., the entire set of ingredients and/or process parameters and the target variable(s)), then in line with the discussion above, the back-end computing platform 102 may modify the data records to include a synthetic value for any variable that is missing, such as by using interpolation to calculate the value or by inserting a predefined value (e.g., 0) for the variable.

As yet another possibility, the set of training data for the underlying predictive model 415 may include data records comprising predicted values that have been output by the predictor model 430 for any recipes that were previously selected by the generator model 410 for inclusion in a given group of candidate recipes (i.e., during a given run of the production prediction component 105. For instance, each time a new candidate recipe is selected by the generator model 410 for inclusion in a given group of candidate recipes, the new candidate recipe may then be scored by the predictor model 430—which outputs a predicted value of the at least target variable along with predicted values of a given set of assessment variables as noted above and described in further detail below—and the predicted values output by the predictor model 430 for the new candidate recipe may then be encoded into a training data record and used by the generator model 410 to re-train the underlying predictive model 415 so as to account for the fact that the new candidate recipe has been selected-which will impact the predicted values and uncertainty estimates output by the underlying predictive model 415 for the space of possible recipes. In this respect, the generator model 410 may function to re-train the underlying predictive model 415 after each selection of a new candidate recipe for inclusion in a given group of candidate recipes other than the last selection for the given group (because the underlying predictive model 415 need not be used to make any further selections at that point in the process).

As still another possibility, if the underlying predictive model 415 is being trained during a subsequent run of the artificial intelligence technology after at least one group of candidate recipes for the recipe prediction project has already been predicted and evaluated by taste testers or the like, the set of training data may include training data records that are sourced from the assessment data that is collected by the product feedback component 106 of the server-side software 103 for the previously evaluated candidate recipes.

The set of training data that is used to train the underlying predictive model 415 may take other forms and/or be obtained from other sources as well—including but not limited to the possibility that certain of the training data may be obtained from a source that is outside of the back-end computing platform 102 (e.g., a third-party database).

Further, the machine learning process that is utilized to train the underlying predictive model 415 may involve any of various machine learning techniques. For instance, as one possible implementation, the machine learning process that is utilized to train the underlying predictive model 415 may involve use of a Gaussian process regression technique that trains a Gaussian process model (sometimes referred to as a “GPM” for short), which is a form of a Bayesian posterior probability distribution. However, other machine learning techniques may be involved in the machine learning process as well, including but not limited to neural-network techniques.

As noted above, the underlying predictive model 415 produced by the machine learning process may comprise any type of predictive model that outputs (i) predicted values of at least one target variable for a space of possible recipes and (ii) uncertainty estimates for the predicted values (among other possible outputs). In this respect, the space of possible recipes may comprise a plurality of dimensions that correspond to the set of independent variables that make up the recipes, such as the set of ingredients and/or process parameters that were defined by the project setup component 104 during setup of the recipe prediction project. To illustrate with an example, if the recipe prediction project is defined to have 5 ingredients, the space of possible recipes may have 5 dimensions, where each respective dimension corresponds to a respective ingredient. Or illustrate with another example, if the recipe prediction project is defined to have 5 ingredients and 2 process parameters, the space of possible recipes may have 7 dimensions, where each respective dimension corresponds to a respective ingredient or process parameter. Many other examples are possible as well.

Further, each respective dimension of the space of possible recipes may represent a measure of the corresponding independent variable, such as a particular ingredient or process parameter. For instance, a first dimension of the space of possible recipes may represent a measure of a first ingredient or process parameter, a second dimension of the space of possible recipes may represent a measure of a second ingredient or process parameter, and so on for each respective dimension of the space of possible recipes. In this respect, each of the dimensions may be defined to have a unit of measurement that depends on the dimension's corresponding ingredient or process parameter. For example, a dimension corresponding to an ingredient may have a unit of measurement that expresses an amount of the ingredient, such as a weight (e.g., grams) or a volume (e.g., liters) of the ingredient, among other possible units of measurement that may express an amount of an ingredient. As another example, a dimension corresponding to a process parameter may have a unit of measurement that expresses an extent of the process parameter, such as a temperature measure for cooking temperature (e.g., a Fahrenheit or Celsius level) or a time measure for cooking time (e.g., a number seconds, minutes, and/or hours), among other possible units of measurement that may express an extent of the process parameter. Other examples are possible as well. Additionally, each of the dimensions may be defined to have a range of possible values that depends on the dimension's corresponding ingredient or process parameter, and, more particularly, depends on the constraints that were defined for the dimension's corresponding ingredient or process parameter during project setup (e.g., a minimum value, a maximum value, a pair of minimum and maximum values, or a fixed value for the ingredient or process parameter).

Each respective data point within this space of possible recipes may then represent a respective recipe comprising a respective combination of values for the independent variables (e.g., the ingredients and/or process parameters) that define the dimensions of the space. For instance, returning to the above example where the space of possible recipes has 5 dimensions corresponding to 5 ingredients, each data point within this example space may represent a respective recipe comprising a respective combination of measures for those 5 ingredients (e.g., a respective amount of each ingredient expressed in terms of weight, volume, etc.). Similarly, returning to the above example where the space of possible recipes has 7 dimensions corresponding to 5 ingredients and 2 process parameters, each data point within this example space may represent a respective recipe comprising a respective combination of measures for those 5 ingredients and 2 process parameters (e.g., a respective amount of each ingredient and a respective extent of each process parameter). Many other examples are possible as well.

In turn, the predicted values of the at least one target variable that are output by the underlying predictive model 415 for the space of possible recipes may comprise values for a quantitative metric that indicates an extent to which a given recipe (e.g., as represented by a given data point within the space) is expected to achieve the target goal for the recipe prediction project. That quantitative metric may take any of various forms, which may depend on the target goal for the recipe prediction project.

As one possibility, if the target goal for the recipe prediction project is to improve consumer enjoyment of the given food product, then the quantitative metric may indicate an extent to which a given recipe is expected to achieve consumer enjoyment of the given food product, where lower values represent a lower level of expected consumer enjoyment and higher values represent a higher level of expected consumer enjoyment. Such a quantitative metric could be expressed using any possible numerical scale, one example of which may be a scale of values ranging from 1 to 10 where 1 represents the lowest level of expected consumer enjoyment and 10 represents the highest level of expected consumer enjoyment.

As another possibility, if the target goal for the recipe prediction project is to reduce cost of the given food product, then the quantitative metric may indicate an extent to which a given recipe is expected to reduce cost of the given food product, where lower values represent a lower level of expected cost reduction and higher values represent a higher level of expected cost reduction. Such a quantitative metric could be expressed using any possible numerical scale, one example of which may be a scale of values ranging from 1 to 10 where 1 represents the lowest level of expected cost reduction and 10 represents the highest level of expected cost reduction.

As yet another possibility, if the target goal for the recipe prediction project is to reduce the environmental impact of the given food product, the quantitative metric may indicate an extent to which a given recipe is expected to reduce the environmental impact of the given food product, where lower values represent a lower level of expected environmental-impact reduction and higher values represent a higher level of expected environmental-impact reduction. Such a quantitative metric could be expressed using any possible numerical scale, one example of which may be a scale of values ranging from 1 to 10 where 1 represents the lowest level of expected environmental-impact reduction and 10 represents the highest level of expected environmental-impact reduction.

The predicted values of the at least one target variable that are output by the underlying predictive model 415 for the space of possible recipes may take other forms as well.

As noted above, the underlying predictive model 415 may also output uncertainty estimates for the space of possible recipes, which are indications of the degree of doubt or uncertainty in the predicted values of the at least one target variable that are output by the underlying predictive model 415. These uncertainty estimates may take various forms and be determined in various manners, which may depend in part on the machine learning technique(s) that are utilized to train the underlying predictive model 415. For example, in a scenario where a Gaussian process regression technique is utilized to train the underlying predictive model 415, the uncertainty estimates may be determined based on respective distributions of possible values that are determined for the recipes within the space of possible recipes. Specifically, for any predicted value that is output by the Gaussian process model, the Gaussian process model may also provide a distribution of possible values that encompasses the predicted value (e.g., a Gaussian distribution, a uniform distribution, etc.) and the uncertainty estimates may be defined based on the variance or standard deviation of the distribution. The uncertainty estimates may take other forms and/or be determined in other manners as well.

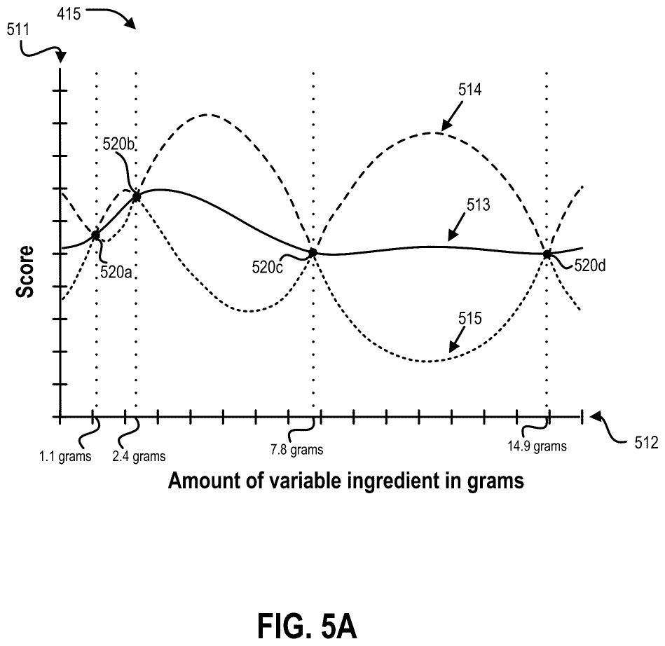

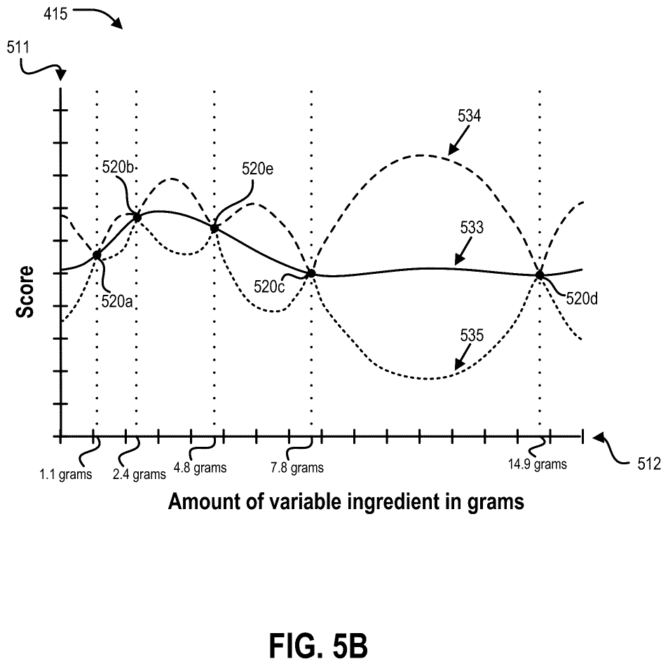

FIG. 5A depicts an illustration of an underlying predictive model 415 that could be trained by the generator model 410 in accordance with one simplified example of the present disclosure. For purposes of illustration and explanation only, the underlying predictive model 415 is shown as having one independent variable, which is the amount of a given ingredient in grams, and one dependent variable, which is the value of a target variable indicating an extent to which a recipe is expected to achieve the target goal. However, it should be understood that, in practice, the predictive function will include multiple independent variables and perhaps also multiple dependent variables.

As shown in FIG. 5A, the underlying predictive model 415 is shown on a two-dimensional plot includes a vertical axis 511 and a horizontal axis 512. The vertical axis 511 depicts a range of possible values for the predicted value of the target variable, while the horizontal axis depicts a range of possible values for the amount of the given ingredient, which in this simplified example defines the space of possible recipes (i.e., each value along the horizontal axis represents a different recipe). Further, the solid curve 513 represents the predicted values that are output by the predictive function 510 for the possible amounts of the given ingredient. Further yet, the dotted curve 514 represents an upper side of the uncertainty estimates for the predicted values of the target variable along the solid curve 513, while the dotted curve 515 represents a lower side of the uncertainty estimates for the predicted values of the target variable along the solid curve 513.

To illustrate one example of the type of relationship that exists between the solid curve 513 and the dotted curves 514, 515, suppose the underlying predictive model 415 is a Gaussian process model and suppose that the predicted value of the target variable for each respective amount of the given ingredient is the mean of a Gaussian (i.e., normal) distribution for the respective amount. In this example, the region bounded by the dotted curves 514, 515 depicts Bayesian credible intervals for the predicted values indicated by the sold curve 513.

As shown, there are certain points 520a-d along the curve 513 where the uncertainty estimates represented by the dotted curves 514, 515 converge to zero. These points 520a-d correspond to recipes that were included in the set of training data for the underlying predictive model 415, such as recipes that were evaluated as part of other recipe prediction projects and have known assessment data that eliminates the uncertainty of the predicted values output for the recipes (e.g., if the underlying predictive model 415 is a Gaussian process model, the uncertainty estimates for the predicted values of the target variable for the recipes to which points 520a-d map are degenerate distributions having variance that is equal to zero). For instance, point 520a represents a first recipe that had 1.1 grams of the given ingredient and was given a target variable value of 5.6 based on evaluator feedback, point 520b represents a second recipe that had 2.4 grams of the given ingredient and was given a target variable value of 6.8 based on evaluator feedback, point 520c represents a third recipe that had 7.8 grams of the given ingredient and was given a target variable value of 5.0 based on evaluator feedback, and point 520d represents a fourth recipe that had 14.9 grams of the given ingredient and was given a target variable value of 5.0 based on evaluator feedback.

The underlying predictive model 415 trained by the generator model 410 may take various other forms as well.

It should also be understood that, in some scenarios, there may be no training data for the discriminator 410 that available at the beginning of the recipe prediction project. In such scenarios, instead of training an underlying predictive model in the first instance, the generator model 410 may begin by generating a generic underlying predictive model that can be utilized to randomly select a first candidate recipe, which may then be re-trained after the selection of the first candidate recipe using predicted values that are output by the predictor model 430.

Referring again to FIG. 4, as noted above, the generator model 410 may select a sample set of candidate recipes from the space of possible recipes based on an analysis of the target variable values uncertainty and estimates output by the underlying predictive model 415. The generator model 410 may utilize any of various techniques to perform this function. For instance, as one possible implementation, the generator model 410 may utilize an optimization technique (e.g., Bayesian optimization) to explore and sample the space of possible recipes based on an analysis of the predicted values and uncertainty estimates output by the underlying predictive model 415. However, the generator model 410 may utilize other techniques to select the sample set of candidate recipes from the space of possible recipes as well.

In an implementation where the generator model 410 is configured to utilize an optimization technique (such as Bayesian optimization) to select the sample set of candidate recipes from the space of possible recipes, the generator model 410 may explore and sample the space of possible recipes by applying an acquisition function that balances between the predicted values and uncertainty estimates output by the underlying predictive model 415 for the recipes within the space. In operation, the acquisition function that is applied may produce values for recipes in the space of possible recipes that reflect how promising the recipes are in terms of balancing the predicted values and uncertainty estimates output by the underlying predictive model 415, and the generator model 410 may select each candidate recipe by maximizing the acquisition function while taking the applicable constraints for the recipe prediction project into account. This acquisition function may be of various types.

For instance, as one possibility, the generator model 410 may explore and sample the space of possible recipes by applying an expected improvement type of acquisition function that evaluates the target value of a recipe as compared to an upper-bound target value selected from known scores of prior recipes. Such an acquisition function EI may be defined as:

$$EI ( θ ; {m}_{opt} ) = δ ( θ ) Φ ( \frac{δ ( θ )}{σ ( θ )} ) + σ ( θ ) ϕ ( \frac{δ ( θ )}{σ ( θ )} )$$

where θ is a set of actual parameters (which represents a recipe in this example) selected from the domain (which represents the space of possible recipes in this example) of the underlying predictive model 415, mₒₚₜ represents the upper-bound target value selected from the known target values of prior recipes, σ(θ) represents the standard error of the distribution of possible scores for θ as contained in the underlying predictive model 415,

$$Φ ( \frac{δ ( θ )}{σ ( θ )} )$$

is the cumulative standard normal of the quotient

$$\frac{δ ( θ )}{σ ( θ )} , ϕ ( \frac{δ ( θ )}{σ ( θ )} )$$

is the standard normal density of the quotient

$$\frac{δ ( θ )}{σ ( θ )} ,$$

and δ(θ) is defined as

$$δ ( θ ) = μ ( θ ) - {m}_{opt} - τ$$

where μ(θ) represents the mean of the distribution of possible scores for θ as contained in the predictive function, and τ represents a configurable trade-off value. Note that the units of t match the units of the scores output by the underlying predictive model 415.

The trade-off value can be configured to strike a balance between exploring of parts of the domain (which is the space of possible candidate recipes in this example) that are distant from the prior recipes and exploiting the knowledge that has been gained from the target values of the prior recipes about where extrema (e.g., maxima or minima) are likely to be found in the domain. As the value of τ decreases, the expected improvement output by the acquisition function becomes more biased toward exploiting the knowledge gained about the underlying predictive model 415 from the known target values of prior recipes. Conversely, as the value of t increases, the expected improvement becomes more biased toward exploring areas of the domain that are distant (e.g., in a Euclidean sense in multidimensional space) from the prior recipes. Essentially, increasing the value of τ increases a penalty associated with candidate recipes that are similar to prior recipes.

In one example, the trade-off value T may be defined as a static (e.g., constant) value. Alternatively, the trade-off value t may be defined dynamically. For example, t may be configured to be a function of the number of the iteration currently being performed by the generator model 410 such that the expected improvement is biased toward exploration in the first few iterations, but becomes increasing biased toward exploitation in later iterations.

It should be understood that the foregoing is just one possible example of an acquisition function that may be applied by the generator model 410, and that the acquisition function may take various other forms as well—including but not limited to the possibility that the acquisition function may be of a type other than expected improvement (e.g., a knowledge-gradient type of acquisition function, an entropy search type of acquisition function, a predictive entropy search type of acquisition function, etc.).

Further, the techniques that are employed by the generator model 410 to ensure that the selection of the candidate recipes complies with the applicable constraints for the recipe generation project (e.g., the constraints regarding individual and/combined amounts of ingredients, factors that are linearly dependent on ingredient amounts, and/or values of process parameters) may take any of various forms, including but not limited to the techniques for complying with constraints that are typically utilized by a Bayesian optimization technique.

To illustrate the foregoing functionality of the acquisition function with reference to the simplified example of FIG. 5A, the generator model 410 may apply an acquisition function that takes both the predicted target value (as depicted the solid curve 513 of FIG. 5A) for a candidate recipe and the uncertainty estimate (the dotted curve 514 and dotted curve 515 of FIG. 5A) into account, along with the constraints that are provided to the generator model 410. For instance, the generator model 410 may apply an acquisition that appraises candidate recipes in a manner that penalizes (i) candidate recipes with low predicted target values and (ii) candidate recipes with low uncertainty estimates for their predicted target values. For example, candidate recipes that are close to recipes in the training data (e.g., the recipes represented by points 520a-d of FIG. 5A) are unlikely to be selected by the generator model 410 even if the predicted target values for these candidate recipes are relatively high because the uncertainty estimates for such recipes will be relatively low. And along similar lines, candidate recipes that have relatively low predicted target values are unlikely to be selected even if the uncertainty estimates for those predicted scores are high. In turn, the generator model 410 may identify an extremum (e.g., a maximum) of the acquisition function (e.g., by identifying where a first derivative of the acquisition function equals zero) that satisfies the constraints and select the recipe that maps to the extremum as a candidate recipe.

Referring again to FIG. 4, at a high level, the predictor model 420 may comprise any type of predictive model that is trained to output, for a given recipe that is passed as input to the predictive model 420, (i) a predicted value of at least one target variable and (ii) predicted values of a given set of assessment variables (e.g., sensory attributes and/or measurements) that are used during training of the predictor model 420.

In accordance with the present disclosure, the predictor model 420 may be trained by carrying out a “multi-task” machine learning process that is capable of exploiting correlations between the values for the at least one target variable and the values for the given set of sensory attributes, which may increase the accuracy of the predicted values of the target variable that are output by the predictor model 420. In operation, such a multi-task machine learning process may be carried out using (i) a set of model configuration parameters for the predictor model 420 and (ii) a set of training data for the predictor model 420. The set of model configuration parameters for the predictor model 420 may include (i) the independent variables for the predictor model 420, which are the set of ingredients and/or process parameters that make up the recipes, and (ii) the dependent variable(s) for the predictor model 420, which includes the at least one target variable as well a given subset of the assessment variables (e.g., sensory attributes and/or measurements) that may be correlated to the at least one target variable. In this respect, the set of model configuration parameters may be defined based on certain of the project configuration parameters for the recipe prediction project, including but not limited to the set of ingredients, the set of process parameters, the target goal, the set of sensory attributes, and/or the set of measurements defined for the recipe prediction project—although it is possible the model configuration parameters for the predictor model 420 may also include additional parameters as well (e.g., model configuration parameters that are defined globally rather than on a project-by-project basis). The model configuration parameters for the predictor model 420 may take other forms as well.

In turn, the set of training data for the underlying predictor model 420 may generally comprise a set of training data records that each include (i) values for at least a subset of the independent variables for the predictor model 420, such as the ingredients and/or process parameters for the recipe prediction project, and (ii) values for at least a subset of the dependent variables for the predictor model 420, such as the at least one target variable and the given subset of the assessment variables (e.g., sensory attributes and/or measurements) that may be correlated to the at least one target variable.

Further, similar to the training data for the underlying predictive model 415 of the generator model 410, the set of training data for the predictor model 420 may include training data records that are obtained from any of various sources. For instance, as one possibility, the set of training data for the predictor model 420 may include training data records that are sourced from a data repository containing historical assessment data that was collected for other recipe prediction projects (e.g., values for a target variable, a set of sensory attributes, and/or a set measurements). In this respect, the back-end computing platform 102 may include functionality for evaluating the stored assessment data that was collected for other recipe prediction projects in order to identify data records comprising assessment data for comparable recipes to the candidate recipes that are to be predicted during the current recipe prediction project, such as data records for recipes that were for food products from a similar product category, were made up of similar ingredients and/or process parameters, had a similar target goal, and/or were assessed according to similar sensory attributes and/or measurements. Additionally, in a scenario where the data records for the comparable recipes do not contain values for the entire set of independent and dependent variables for the predictor model 420 (e.g., the entire set of ingredients and/or process parameters, the target variable(s), and the entire set of assessment variables), the back-end computing platform 102 may modify the data records to include a synthetic value for any variable that is missing, such as by using interpolation to calculate the value or by inserting a predefined value (e.g., 0) for the variable.

As another possibility, the set of training data for predictor model 420 may include training data records that are sourced from a set of assessment data that was uploaded by a user as part of setting up the recipe prediction project, which may include historical assessment data that was captured during prior real-world testing of recipes and/or synthetic assessment data that was created independent of any real-world testing of recipes. In this respect, the back-end computing platform 102 may include functionality for evaluating the set of assessment data uploaded by the user in order to identify data records comprising assessment data for comparable recipes to the candidate recipes that are to be predicted during the current recipe prediction project, such as data records for recipes that were for food products from a similar product category, were made up of similar ingredients and/or process parameters, had a similar target goal, and/or were assessed according to similar sensory attributes and/or measurements. However, in other implementations, the back-end computing platform 102 may be configured to assume that assessment data uploaded by a user as part of setting up the recipe prediction project is comparable and forgo the step of evaluating such assessment data to identify data records for comparable recipes. Additionally, in a scenario where the data records uploaded by the user do not contain values for the entire set of independent and dependent variables for the predictor model 420 (e.g., the entire set of ingredients and/or process parameters, the target variable(s), and the entire set of assessment variables), then in line with the discussion above, the back-end computing platform 102 may modify the data records to include a synthetic value for any variable that is missing, such as by using interpolation to calculate the value or by inserting a predefined value (e.g., 0) for the variable.

As yet another possibility, if the predictor model 420 is being trained during a subsequent run of the artificial intelligence technology after at least one group of candidate recipes for the recipe prediction project has already been predicted and evaluated by taste testers or the like, the set of training data may include training data records that are sourced from the assessment data that is collected by the product feedback component 106 of the server-side software 103 for the previously evaluated candidate recipes.

The set of training data that is used to train the predictor model 420 may take other forms and/or be obtained from other sources as well—including, but not limited to, the possibility that certain of the training data may be obtained from a source that is outside of the back-end computing platform 102 (e.g., a third-party database).

Further, the multi-task machine learning process that is utilized to train the predictor model 420 may involve any of various machine learning techniques. For instance, as one possible implementation, the multi-task machine learning process that is utilized to train the predictor model 420 may involve use of a Gaussian process regression technique that trains a Gaussian process model (or a “GPM” for short) in a multi-task learning setting that accounts for the multiple different dependent variables of the predictor model 420. However, other machine learning techniques may be involved in the multi-task machine learning process for training the predictor model 420 as well, including, but not limited to, neural-network techniques carried out in a multi-task learning setting.

As noted above, the predictor model 420 produced by the machine learning process may comprise any type of predictive model that outputs, for a given recipe that is passed as input to the predictive model 420, (i) a predicted value of at least one target variable and (ii) predicted values of a given set of assessment variables (e.g., sensory attributes and/or measurements) that are used during training of the predictor model 420. Depending on its type, the predictor model 420 may output other values as well. For instance, if the predictor model 420 is a Gaussian process model, then the predictor model 420 may also out uncertainty estimates for its predicted values, which may or may not be used during the process of predicting the candidate recipes depending on the implementation. For instance, as one possible implementation, the predictor model's uncertainty estimates for the predicted value of the at least one target variable could be used by the generator model 410 during re-training of its underlying predictive model 415. In this respect, the re-trained version of the underlying predictive model 415 may have an output that reflects both the predictor model's predicted value of the target variable for a previously selected candidate recipe and also the predictor model's uncertainty estimate for that predicted value. As another possible implementation, the predictor model's uncertainty estimates for the predicted value of the at least one target variable could be used as a basis for determining whether the predictor model's predicted value of the at least one target variable is sufficiently reliable to be used as training data for the underlying predictive model 415 of the generator model 410. The predictor model's uncertainty estimates for the predicted value of the at least one target variable could be used in other manners as well. However, in still other implementations, the predictor model 420 either may not be configured to output uncertainty estimates, or the predictor model 420 may be configured to output uncertainty estimates but those uncertainty estimates may not otherwise be used during the process of predicting the candidate recipes—in which case the uncertainty estimates that are output by the re-trained version of the underlying predictive model 415 for the predicted target value of the previously selected candidate recipe may be determined without reference to uncertainty estimates output by the predictor model 420. The output of the predictor model 420 may take other forms and be utilized in other manners as well.

Similar to the predicted values of the at least one target variable that are output by the underlying predictive model 415 of the generator model 410, the predicted values of at least one target variable that are output by the predictor model 420 may comprise values for a quantitative metric that indicates an extent to which a given recipe (e.g., a candidate recipe selected by the generator model 410) is expected to achieve the target goal for the recipe prediction project. That quantitative metric may take any of various forms, which may depend on the target goal for the recipe prediction project.

As one possibility, if the target goal for the recipe prediction project is to improve consumer enjoyment of the given food product, then the quantitative metric may indicate an extent to which a given recipe is expected to achieve consumer enjoyment of the given food product, where lower values represent a lower level of expected consumer enjoyment and higher values represent a higher level of expected consumer enjoyment. Such a quantitative metric could be expressed using any possible numerical scale, one example of which may be a scale of values ranging from 1 to 10 where 1 represents the lowest level of expected consumer enjoyment and 10 represents the highest level of expected consumer enjoyment.

As another possibility, if the target goal for the recipe prediction project is to reduce cost of the given food product, then the quantitative metric may indicate an extent to which a given recipe is expected to reduce cost of the given food product, where lower values represent a lower level of expected cost reduction and higher values represent a higher level of expected cost reduction. Such a quantitative metric could be expressed using any possible numerical scale, one example of which may be a scale of values ranging from 1 to 10 where 1 represents the lowest level of expected cost reduction and 10 represents the highest level of expected cost reduction.

As yet another possibility, if the target goal for the recipe prediction project is to reduce the environmental impact of the given food product, the quantitative metric may indicate an extent to which a given recipe is expected to reduce the environmental impact of the given food product, where lower values represent a lower level of expected environmental-impact reduction and higher values represent a higher level of expected environmental-impact reduction. Such a quantitative metric could be expressed using any possible numerical scale, one example of which may be a scale of values ranging from 1 to 10 where 1 represents the lowest level of expected environmental-impact reduction and 10 represents the highest level of expected environmental-impact reduction.

The predicted values of the at least one target variable that are output by the predictor model 420 may take other forms as well.

Further, the predicted values of the given set of assessment variables that are output by the predictor model 420 may comprise values for some set of sensory attributes and/or measurements that were used during the training of the predictor model 420 (e.g., sensory attributes and/or measurements that may have some correlation with the at least one target variable). However, as explained further below, the predicted values of the given set of assessment variables that are output by the predictor model 420 may not actually be utilized during the process of predicting the candidate recipes. Rather, the primary purpose of including the given set of assessment variables as dependent variables for the predictor model 420 is that, by applying a multi-task machine learning process to training data that includes values for both the at least one target variable and also the given set of assessment variables, correlations between the at least one target variable and the given set of assessment variables may be exploited in order to produce a predictive model that more accurately predicts the at least one target variable.

In this respect, the accuracy of the predictor model 420 may depend on which particular set of assessment variables are included as dependent variables for the predictor model 420, as different assessment variables may have different levels of correlation with the at least one target variable. For instance, some assessment variables may have little to no correlation with the at least one target variable, other assessment variables may have some intermediate level of correlation with the at least one target variable, and still other assessment variables may have a strong level of correlation with the at least one target variable. Thus, it is generally desirable to select a given set of assessment variables that best maximizes the accuracy of the predictor model 420 (or at least provide a threshold level of accuracy). This may be accomplished in various ways.

As one possible implementation, the selection of the given set of assessment variables to include as dependent variables for the predictor model 420 may be based on prior knowledge regarding correlations between the available assessment variables and the at least one target variable, which may be based on a computer-based analysis of historical assessment data, subject matter expertise of individuals with product development experience, or some combination thereof, among other possible examples.

As another possible implementation, the selection of the given set of assessment variables to include as dependent variables for the predictor model 420 may be determined through a process that involves training multiple different candidate predictive models such that each has a different respective set of assessment variables as dependent variables, assessing the accuracy of the candidate predictive models relative to one another, and then based on the assessed accuracy, selecting a given one of the candidate predictive models to use as the predictor model 420. In this respect, the function of the assessing the accuracy of the candidate predictive models relative to one another may involve, for each candidate predictive model, (i) inputting a test dataset comprising assessment data records for reference recipes that have known values of the least one target variable into the candidate predictive model, which may cause the candidate predictive model to output predicted values of the least one target variable for the reference recipes, (ii) comparing the predicted values of the least one target variable to the known values of the least one target variable for the reference recipes, and (iii) based on the comparison, determining a measure of the error exhibited by the candidate predictive model across the test dataset-which may then be used to evaluate the candidate predictive model against other candidate predictive models and thereby select the candidate predictive model with the lowest measure of error as the predictor model 420. However, the function of the assessing the accuracy of the candidate predictive models relative to one another could take other forms as well.

The given set of assessment variables that are included as dependent variables for the predictor model 420 may also be selected in other ways.

As noted above, the predictor model 420 may be used to determine a predicted value of the at least one target variable for a candidate recipe that is previously selected by the generator model 410 during a prior iteration of its functionality, and that predicted value of the at least one target variable for the respective candidate recipe may then be fed back to the generator model 410 so that it can be used as training data for the underlying predictive model 415 during one or more subsequent iterations of the generator model's functionality. In this respect, after the generator model 410 selects a first candidate recipe, the steps of using the predictor model 420 to output a predicted target value for a previously selected candidate recipe and then carrying out another iteration of the generator model's functionality using the predictor model's predicted target value for the previously selected candidate recipe as training data for the underlying predictive model 415 may be carried out one or more times in order to select one or more additional candidate recipes.

To illustrate with an example, FIG. 5B illustrates a re-trained version of the example underlying predictive model 415 of FIG. 5A that has been re-trained based on a predicted value of the target variable for a previously selected candidate recipe that was output by the predictor model 420. As shown, the output of the re-trained version of the example underlying predictive model 415 includes an additional point 520e that represents a recipe that was selected by the generator model 420 as a candidate recipe during a prior iteration of the generator model's functionality, where the score for point 520e shown in FIG. 5B reflects the predicted value of the target value for the recipe that was determined by the predictor model 420. As further shown in FIG. 5B, the uncertainty estimates for the recipe represented by point 520e have been reduced relative to the uncertainty estimates shown in FIG. 5A to reflect that this is now a selected recipe.

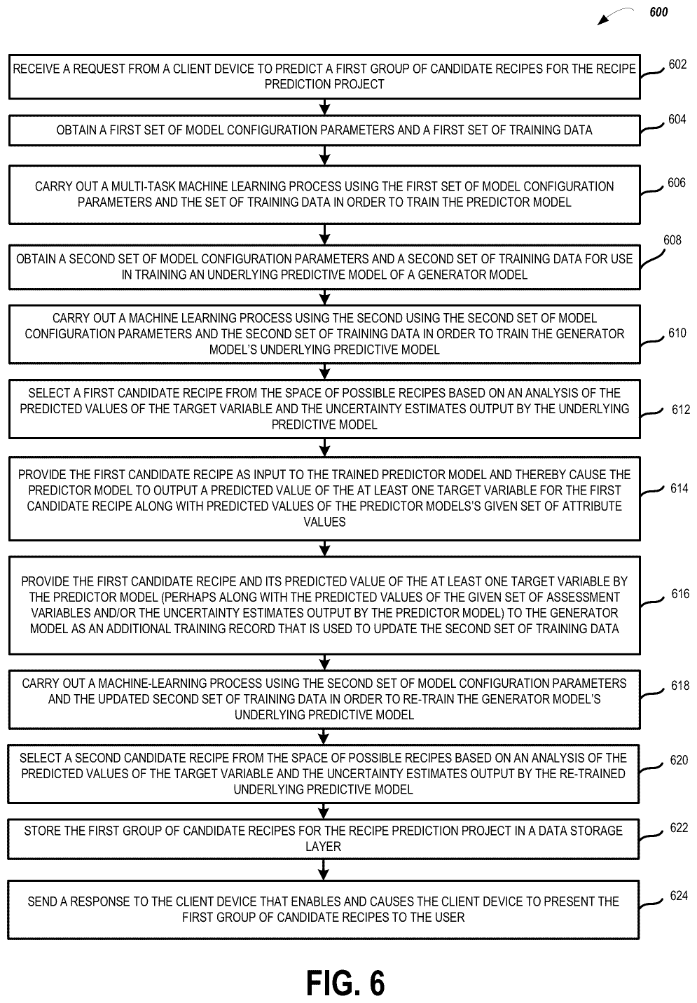

The functionality that is provided by the product prediction component 105 of the server-side software 103 in order to generate a first (or “initial”) group of candidate recipes for the recipe prediction project may take various forms, and one possible implementation of that functionality is illustrated in FIG. 6. For purposes of illustration, the example functionality 600 of FIG. 6 is described as being carried out by the back-end computing platform 102 of FIG. 1, but it should be understood that the example functionality 600 of FIG. 6 may be carried out by any computing platform that is capable of running the software disclosed herein. Further, it should be understood that the example functionality 600 of FIG. 6 is merely described in this manner for the sake of clarity and explanation and that the example functionality 600 may be implemented in various other manners, including the possibility that functions may be added, removed, rearranged into different orders, combined into fewer blocks, and/or separated into additional blocks depending upon the particular embodiment.

As shown in FIG. 6, the example functionality 600 may begin at block 602 with the back-end computing platform 102 receiving a request from a client device 110 that has accessed the disclosed software tool, such as example client device 110a, to predict a first group of candidate recipes for the recipe prediction project. In practice, this request may take the form of one or more request messages (e.g., one or more HTTP messages) that are sent over the respective communication path between the client device 110a and the back-end computing platform 102 (which as noted above may include at least one data network), and in at least some implementations, the one or more request messages may be sent via an API. Further, the request may include an identifier of recipe prediction project for which the request is being made, among other possible information that may be included in the request. Further yet, the request may be sent by the client device 110a in response to receiving a user request via the GUI of the software tool (e.g., a user selection of a “Request New Batch” button). The request to predict the first group of candidate recipes for the recipe prediction project may take other forms and/or be received in other manners as well.

At block 604, after receiving the request, the back-end computing platform 102 may obtain (i) a first set of model configuration parameters and (ii) a first set of training data for use in training a predictor model of the type disclosed herein. In this respect, the first set of model configuration parameters for the predictor model may take any of the forms described above. Likewise, the first set of training data may take any of the forms described above, and may be sourced from one or both of (i) assessment data that has been collected for other recipe prediction projects or (ii) assessment data that was uploaded by a user during setup of the recipe prediction project. On the other hand, given that this is the first run of the recipe prediction functionality, the training data will typically not include any assessment data that has been collected for the recipe prediction project at this point within the project—but during subsequent runs, the training data may be expanded to include assessment data collected for the recipe prediction project using the product feedback component 106.

As part of obtaining the first set of training data for use in training the predictor model of the type disclosed herein, the back-end computing platform 102 may also perform certain pre-processing operations on the assessment data. These pre-processing operations may take various forms.

As one possibility, in a scenario where the assessment data for a previously defined recipe does not include a value of a particular independent or dependent variable for the predictor model (e.g., an ingredient amount, process parameter, sensory attribute, measurement, etc.), the back-end computing platform 102 may generate a synthetic value for the particular independent or dependent variable using imputation or population of a predefined reference value.

As another possibility, in a scenario where the assessment data includes multiple data records for either the same recipe (e.g., the same combination of ingredient amounts) or correlated recipes, the back-end computing platform 102 may reduce the multiple data records down to a single record by either removing all but one data record or by aggregating the data records together into a single data record.

As yet another possibility, in a scenario where the selection of the given set of assessment variables to be included as dependent variables for the predictor model involves testing of multiple candidate predictive models, the back-end computing platform 102 may split the obtained assessment data into a first set of training data and a second set of test data that is to be used during the process of assessing the candidate predictive models relative to one another.

As still another possibility, the back-end computing platform 102 may scale certain values of certain data records.

The back-end computing platform 102 may perform other types of pre-processing operations on the assessment data as well.

At block 606, the back-end computing platform 102 may carry out a multi-task machine learning process using the first set of model configuration parameters and the first set of training data in order to train the predictor model of the type disclosed herein, which as noted above may comprise a predictive model that is trained to output, for a given recipe that is passed as input to the predictive model 420, (i) a predicted value of at least one target variable, (ii) predicted values of a given set of assessment variables (e.g., sensory attributes and/or measurements) that are used during training of the predictor model 420, and perhaps also (iii) uncertainty estimates for the predicted value of the at least one target variable.

In line with the discussion above, as part of the process of training the predictor model, the back-end computing platform 102 may select a given set of assessment variables (e.g., sensory attributes and/or measurements) to include as dependent variables for the predictor model. The back-end computing platform 102 may make this selection using any of various techniques, including but not limited to the techniques explained above (e.g., by creating multiple different candidate predictive models and assessing the candidate predictive models relative to one another to identify the candidate predictive model having the lowest error).

At block 608, the back-end computing platform 102 may obtain (i) a second set of model configuration parameters and (ii) a second set of training data for use in training an underlying predictive model of a generator model of the type disclosed herein. In this respect, the second set of model configuration parameters for underlying predictive model of a generator model may take any of the forms described above. Likewise, the second set of training data may take any of the forms described above, and may be sourced from one or both of (i) assessment data that has been collected for other recipe prediction projects or (ii) assessment data that was uploaded by a user during setup of the recipe prediction project. On the other hand, given that this is the first run of the recipe prediction functionality, the training data will typically not include any assessment data that has been collected for the recipe prediction project at this point within the project—but during subsequent runs, the training data may be expanded to include assessment data collected for the recipe prediction project using the product feedback component 106.

As part of obtaining the second set of training data for use in training the underlying predictive model of the generator model, the back-end computing platform 102 may also perform certain pre-processing operations on the assessment data, including but not limited to the pre-processing operations described above.

At block 610, as part of a first iteration of the generator model's functionality, the back-end computing platform 102 may carry out a machine learning process using the second set of model configuration parameters and the second set of training data in order to train the generator model's underlying predictive model, which as noted above may comprise a predictive model that is trained to output (i) predicted values of at least one target variable for a space of possible recipes that each indicates an extent to which a respective recipe in the space is expected to achieve the target goal and (ii) uncertainty estimates for the predicted values (among other possible outputs).

At block 612, as part of the first iteration of the generator model's functionality, the back-end computing platform 102 may select a first candidate recipe from the space of possible recipes based on an analysis of the predicted values of the target variable and the uncertainty estimates output by the underlying predictive model that was trained at block 612. In line with the discussion above, the back-end computing platform 102 may utilize any of various techniques to perform this function, including but not limited to an optimization technique such as Bayesian optimization that applies and maximizes an acquisition function that balances between the predicted values and uncertainty estimates output by the underlying predictive model. Further, in line with the discussion above, the back-end computing platform 102 may taking any applicable constraints for the recipe prediction project into account when applying the optimization technique (e.g., the constraints regarding individual and/or combined amounts of ingredients, factors that are linearly dependent on ingredient amounts, and/or values of process parameters).

At block 614, after selecting the first candidate recipe using the generator model, the back-end computing platform 102 may provide the first candidate recipe as input to the trained predictor model and thereby cause the predictor model to output a predicted value of the at least one target variable for the first candidate recipe along with predicted values of the predictor model's given set of attribute variables and perhaps also uncertainty estimates for the predicted value of the at least one target variable.

At block 616, the back-end computing platform 102 may provide the first candidate recipe and its predicted value of the at least one target variable output by the predictor model (perhaps along with the predicted values of the given set of assessment variables and/or the uncertainty estimates output by the predictor model) to the generator model as an additional training data record that is used to update the second set of training data.

At block 618, as part of a second iteration of the generator model's functionality, the back-end computing platform 102 may carry out a machine learning process using the second set of model configuration parameters and the updated second set of training data in order to re-train the generator model's underlying predictive model.

At block 620, as part of the second iteration of the generator model's functionality, the back-end computing platform 102 may select a second candidate recipe from the space of possible recipes based on an analysis of the predicted values of the target variable and the uncertainty estimates output by the underlying predictive model that was re-trained at block 620.

Thereafter, the back-end computing platform 102 may repeat the functionality one or more additional times in order to select one or more additional candidate recipes to include in the first group of candidate recipes, until all of the candidate recipes to include the first group of candidate recipes have been selected.

At block 622, the back-end computing platform 102 may store the first group of candidate recipes for the recipe prediction project in a data storage layer of the platform (e.g., in a relational database) so that the first group of candidate recipes can later be accessed and reviewed by individuals involved in the recipe prediction project, such as product developers, testers, etc.

Additionally, at block 624, the back-end computing platform 102 may send a response to the client device 110a that enables and causes the client device 110a to present the first group of candidate recipes to the user. In practice, this request may take the form of one or more response messages (e.g., one or more HTTP messages) that are sent over the respective communication path between the back-end computing platform 102 and the client device 110a (which as noted above may include at least one data network), and in at least some implementations, the one or more response messages may be sent via an API. Further, the response that is sent to the client device 110a may comprise instructions and data for presenting a visualization of the first group of candidate recipes within the GUI of the software tool to the user. That visualization may take any of various forms. For instance, as one possibility, the visualization of the first group of recipes may comprise a representation of each respective recipe in the first group of candidate recipes that shows the respective recipe's ingredient and/or process parameter values (or at least a subset thereof) in the form of a graph (e.g., a bar graph) or a textual list, among other possible representations of the candidate recipes. The visualization of the first group of candidate recipes may also take other forms, including but not limited to the possibility that each respective recipe in the first group of candidate recipes may be shown in a separate visualization.

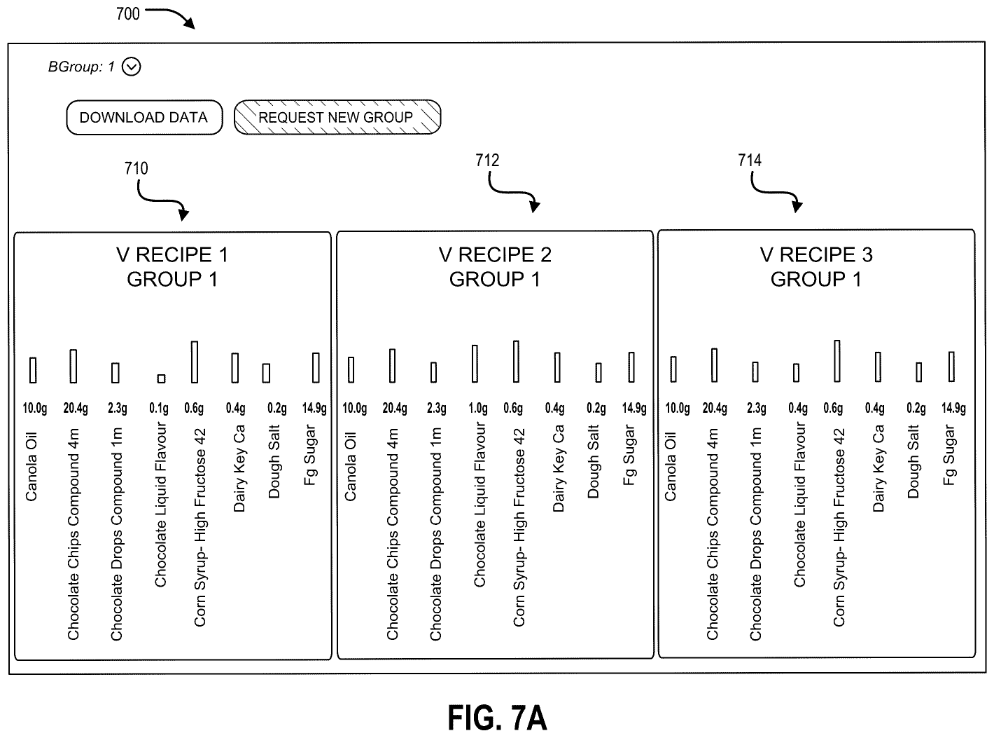

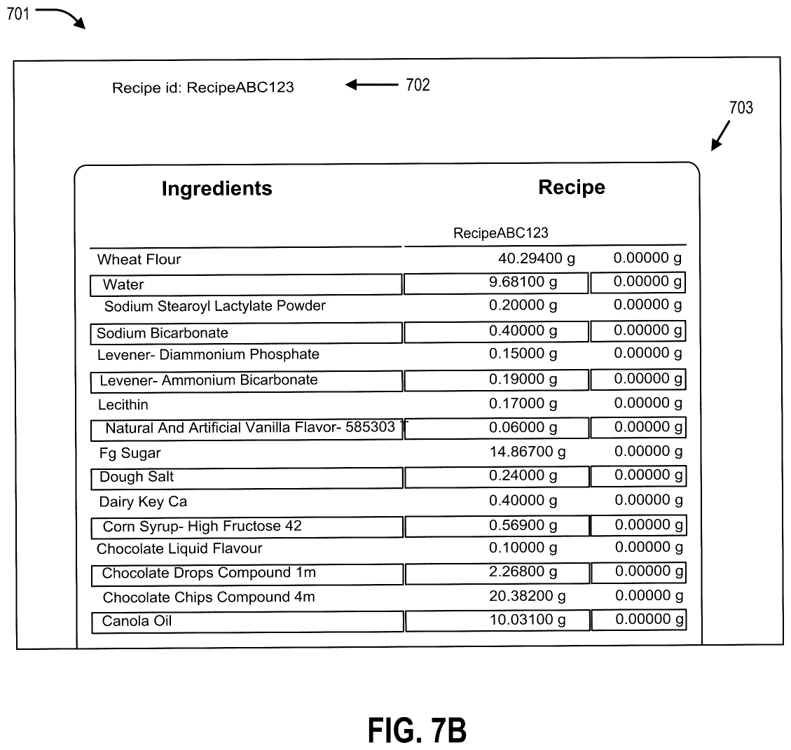

For the purposes of illustration, FIG. 7A provides one example of a GUI view 700 through which a user can view the first group of candidate recipes. As shown, the GUI view 700 includes display tiles 710, 712, 714 to provide details about the candidate recipes (collectively referred to as the “Group 1” of recipes in this example) that were predicted by the product prediction component 105. Specifically, the display tile 710 lists ingredients and ingredient amounts (both numerically and graphically) for a first recipe (“Recipe 1”) in a series of columns, the display tile 712 lists ingredients and ingredient amounts (both numerically and graphically) for a second recipe (“Recipe 2”) in a series of columns, and the display tile 714 lists ingredients and ingredient amounts (both numerically and graphically) for a third recipe (“Recipe 3”) in a series of columns. In this example, if additional ingredients are included in the recipes of “Group 1,” it is contemplated that a user could scroll sideways on each of the display tiles 710, 712, 714, respectively, to view the additional ingredients and ingredient amounts (and, if applicable, the values of any process parameters that may vary from recipe to recipe within “Group 1.”). Furthermore, it is also contemplated that a user could select (e.g., double click via a computer mouse and a cursor) any one of the display tiles 710, 712, 714 to request that the GUI display an expanded view of the selected display tile. In this manner, a user can view the details for each recipe in “Group 1” as desired. Although three recipes are mentioned in Group 1 in this example, groups of candidate recipes identified by the product prediction component 105 may include more or fewer candidate recipes. For example, it is contemplated that additional display tiles could be revealed in the GUI by scrolling down or sideways on the GUI view 700 if more than three candidate recipes were to be included in Group 1.

FIG. 7B provides another example of a GUI view 701 that displays a candidate recipe. As shown, the GUI view 701 includes a recipe identifier 702 and a table 703 with an “Ingredients” column that provides a textual listing of the ingredients included in the recipe (e.g., as specified in the set of ingredients found in the project configuration parameters) and the corresponding amounts of such ingredients.

The GUI views through which a user can view the candidate recipes may also take various other forms.

Returning to FIG. 6, the functionality that is provided by the product prediction component 105 of the server-side software 103 in order to predict the first group of candidate recipes for the recipe prediction project may take other forms as well.

For instance, in a scenario where the at least one target variable includes a target variable for which the value of a candidate recipe can be determined without using a predictor model, then instead of using a predictor model to determine the value of the target variable for a previously selected candidate recipe that is fed back to the generator model and used as training data for re-training the underlying predictive model of the generator model, the back-end computing platform 102 may determine the value of the target variable for the previously selected candidate recipe in some other way and then feed that determined value back to the generator model. And in such a scenario, a predictor model may not be trained or used by the back-end computing platform 102 unless there is at least one other target value for the recipe prediction project that gives rise to a need to predict values.

To illustrate with an example, if the at least one target variable includes a variable that indicates the cost of a candidate recipe, the value of that cost variable can be determined based on the respective amount and respective per-unit cost of each ingredient included in the candidate recipe, which are known values that generally need not be predicted using a predictor model. In this respect, after each candidate recipe is selected by the generator model, the back-end computing platform 102 may (i) determine the cost of the candidate recipe based on the respective amount and respective per-unit cost of each ingredient included in the candidate recipe and then (ii) provide the candidate recipe and its determined cost value to the generator model as an additional training data record that is used to update the training data for training the generator model's underlying predictive model.

The artificial intelligence that is applied by the product prediction component 105 and/or the functionality that is carried out by the product prediction component 105 of the server-side software 103 may take various other forms as well.

After the product prediction component 105 has predicted the initial group of candidate recipes for the recipe prediction project, each of the candidate recipes in the initial group may then be accessed and used to prepare a respective batch of test samples of the given food product that are to be evaluated by human taste testers and/or measurement equipment. For instance, a first candidate recipe in the initial group of candidate recipes may be used to prepare a first batch of test samples for evaluation, a second candidate recipe in the initial group of candidate recipes may be used to prepare a first batch of test samples for evaluation, and so on for each of the other candidate recipes in the initial group of candidate recipes.

Additionally, in some implementations, the disclosed AIPD software tool may enable a user (e.g., a product developer) to add other user-defined candidate recipes to the recipe prediction project that are to be evaluated along with the predicted candidate recipes. For instance, the disclosed AIPD software tool may include a GUI view through which a user can create a user-defined candidate recipe by inputting values for a set of ingredients and/or process parameters that are to be included the user-defined candidate recipe (which may be the same as or different than the set of ingredients and/or process parameters that are included in the predicted candidate recipes), and this user-defined candidate recipe can then be stored and presented along with the predicted candidate recipes such that the user-defined candidate recipe can similarly be accessed and used to prepare a respective batch of test samples of the given food product that are to be evaluated by human taste testers and/or measurement tools.

The process of using the candidate recipes to prepare the batches of test samples for the given food product may take various forms, which may depend on the particular type of food product and the particular set of ingredients and/or process parameters that make up the candidate recipes, among other factors.

To illustrate with a first example where the candidate recipes are for a cookie product, the process for preparing a batch of test samples in accordance with a given candidate recipe may involve measuring out the specified amounts of the ingredients included in the given candidate recipe (e.g., granulated sugar, butter, brown sugar, eggs, vanilla flavoring, baking soda, etc.), mixing the ingredients together to form a dough, separating the dough into individual balls, arranging the dough balls on a cookie sheet, preheating an oven to a given temperature, and baking the dough balls on the cookie sheet in the oven until the dough balls flatten into cookies, where at least some of these steps may be carried out in accordance with certain process parameters that are specified as part of the given candidate recipe (e.g., the order in which to add the ingredients, the type of mixing tool to use, the settings for the mixing tool, the duration of the mixing, the size of dough balls, the spacing of the dough balls on the cookie sheet, the temperature of the oven, the cooking time, etc.).

To illustrate with a second example where the candidate recipes are for a carbonated beverage product, the process for preparing a batch of test samples in accordance with a given candidate recipe may involve measuring out the specified amounts of a first subset of the ingredients included in the given candidate recipe (e.g., sweeteners such as sugar or aspartame, natural flavors, artificial flavors, etc.), combining the first subset of ingredients together into a batch tank and agitating the combination to form a syrup, sterilizing the syrup (e.g., via ultraviolet radiation or pasteurization), mixing the syrup with a specified amount of purified (e.g., distilled) water in a pressurized vessel via proportioners that regulate the flow rates and the ratio of the syrup to the water, and carbonating the mixture via a carbonator, where at least some of these steps may be carried out in accordance with certain process parameters that are specified as part of the given candidate recipe (e.g., the order in which to add the ingredients to the batch tank, the rate of agitation, the duration of the agitation, the method of sterilization, pressure levels, flow rates, temperature, etc.).

It will be understood that these examples are merely provided for purposes of illustration, and that the given food product, the candidate recipes, and/or the process of using the candidate recipes to prepare the batches of test samples for the given food product may take many other forms as well.

After the candidate recipes in the initial group have been used to prepare the batches of test samples of the given food product, those batches of test samples may then be evaluated by human taste testers and/or measurement equipment. Such an evaluation may take any of various forms.

For instance, as a starting point, a panel of human taste testers may be assembled in order to perform an evaluation of the batches of test samples that were prepared in accordance with the initial group of candidate recipes. That panel of taste testers may include “amateur” taste testers that have been recruited to evaluate the test products, such as sampling of individuals that are expected to be consumers of the given food product, among other possibilities. Additionally or alternatively, the panel of taste testers may include professional taste testers that are hired to evaluate the test products.

In order to carry out the evaluation, the panel of taste testers could either be gathered together at a single test site, spread across multiple test sites, or in some cases, could perform the evaluation from the comfort of their own homes (in which case the test samples may be shipped to the taste testers rather than being provided to them in person), among other possibilities. Regardless of the location(s) where the evaluation takes place, each of the taste testers will be asked to evaluate the test samples of the given food product and provide feedback based on that evaluation, which may include (i) an assessment of how well each of the evaluated test samples accomplishes the target goal and/or (ii) an assessment of certain sensory attributes for each of the evaluated test samples (e.g., attributes related to appearance, aroma, flavor, texture, aftertaste, etc.), which may comprise the set of sensory attributes defined during setup of the recipe prediction project and/or some other set of sensory attributes (e.g., a more granular set of sensory attributes for professional taste testers).

As noted above, in addition to having a panel of taste testers evaluate the batches of test samples, certain measurement attributes of the test samples could also be evaluated using measurement tools, examples of which may include the dimensions of the test samples (e.g., length, width, height, etc.), the weight of the test samples, the volume of the test samples, the moisture content of the test samples, and/or the color of the test samples, among various other examples.

At a high level, the example product feedback component 106 of the server-side software 103 may cause the back-end computing platform 102 to carry out functionality for collecting assessment data from evaluators (e.g., potential consumers, professional taste testers, laboratory technicians, etc.).

In accordance with the present disclosure, this assessment data for the test samples (e.g., the feedback from the taste testers and/or the measurement values captured by the measurement tools) may then be collected by the disclosed AIPD software tool so that such assessment data can be used as training data in the future (among other possible purposes for the assessment data). For instance, referring back to FIG. 1, the product feedback component 106 of the server-side software 103 may cause the back-end computing platform 102 to carry out functionality for collecting assessment data for test samples that were prepared and evaluated as part of the recipe prediction project.

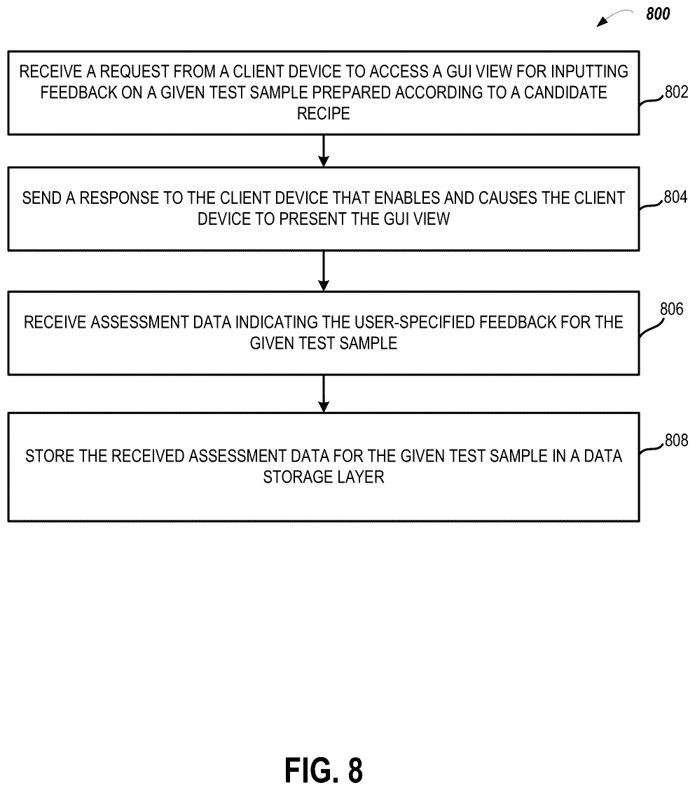

The functionality that is provided by the product feedback component 106 of the server-side software 103 may take various forms, and one possible implementation of that functionality is illustrated in FIG. 8. For purposes of illustration, the example functionality 800 of FIG. 8 is described as being carried out by the back-end computing platform 102 of FIG. 1, but it should be understood that the example functionality of FIG. 8 may be carried out by any computing platform that is capable of running the software disclosed herein. Further, it should be understood that the example functionality of FIG. 8 is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 8, the example functionality 800 may begin at block 802 with the back-end computing platform 102 receiving a request from a client device 110 associated with a user (e.g., a taste tester or an individual acting on behalf of a taste tester), such as example client device 110b, to access a GUI view of the disclosed AIPD software tool for inputting feedback on a given test sample that was prepared in accordance with a given candidate recipe of the recipe prediction project and was then evaluated by a given taste tester. In practice, this request may take the form of one or more request messages (e.g., one or more HTTP messages) that are sent over the respective communication path between the client device 110b and the back-end computing platform 102 (which as noted above may include at least one data network), and in at least some implementations, the one or more request messages may be sent via an API. Further, the request may include an identifier of the given taste tester, the given candidate recipe, and/or the recipe prediction project, among other possible information that may be included in the request. Further yet, the request may be sent by the client device 110b in response to receiving a user request via the GUI of the AIPD software tool (e.g., a user selection of the given candidate recipe within a visualization of candidate recipes). The request to access a GUI view for inputting feedback on a given test sample may take other forms and/or be received in other manners as well.

At block 804, after receiving the request to access the GUI view for inputting feedback on the given test sample, the back-end computing platform 102 may send a response to the client device 110b that enables and causes the client device 110b to present the GUI view for inputting feedback on a given test sample. In practice, this request may take the form of one or more response messages (e.g., one or more HTTP messages) that are sent over the respective communication path between the back-end computing platform 102 and the client device 110b (which as noted above may include at least one data network), and in at least some implementations, the one or more response messages may be sent via an API. Further, the response that is sent to the client device 110b may comprise instructions and data for rendering the requested GUI view, which the client device 110b may utilize to present the GUI view to the user. The response to the client device 110b may take other forms and/or be sent in other manners as well.

In accordance with the present disclosure, the GUI view for inputting feedback on the given test sample that is presented by the client device 110b may include of any of various GUI input elements (e.g., buttons, sliders, text fields, dropdown lists, etc.) that enable the user to input any of various types of feedback for the given test sample. For instance, in line with the discussion above, the GUI view for inputting feedback on the given test sample may include a GUI input element that enables the user to input an assessment of how well the given test sample accomplishes the target goal of the recipe prediction project, where the GUI input element may take the form of a slider bar, a set of radio buttons, or a dropdown list, among other possibilities.

To illustrate with an example, if the target goal of the recipe prediction project is to improve consumer enjoyment of the given food product, the GUI view for inputting feedback on the given test sample may include a GUI input element that enables the user to input a value for a quantitative or qualitative metric indicating the consumer enjoyment of the given test sample as assessed by the given taste tester (e.g., on a scale from “Dislike Extremely” to “Like Extremely”). Other examples are possible as well.

Additionally, in line with the discussion above, the GUI view for inputting feedback on the given test sample may include GUI input elements that enable the user to input an assessment of certain sensory attributes for the given test sample, where the GUI input elements may each take the form of a slider bar, a set of radio buttons, or a dropdown list, among other possibilities. To illustrate with an example, if the set of sensory attributes that is defined for the recipe prediction project includes 5 sensory attributes, the GUI view for inputting feedback on the given test sample may include a respective GUI input element for each of the 5 sensory attributes that enables the user to input a value for a quantitative or qualitative metric indicating the extent of the sensory attribute perceived by the given taste tester while evaluating the given test sample, such as an extent of a particular kind of aroma (e.g., on a scale from weak to strong), an extent of a particular aspect of the sample's appearance (e.g., on a scale from not enough to too much), an extent of a particular kind of flavor or aftertaste (e.g., on a scale from weak to strong) and/or an extent of a particular kind of texture, among other possibilities. Other examples are possible as well.

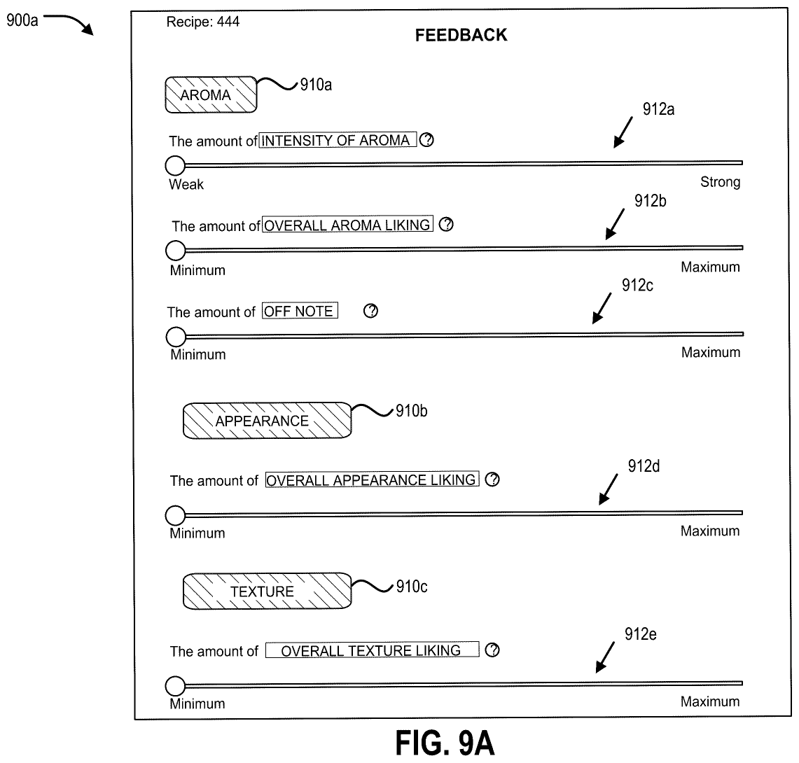

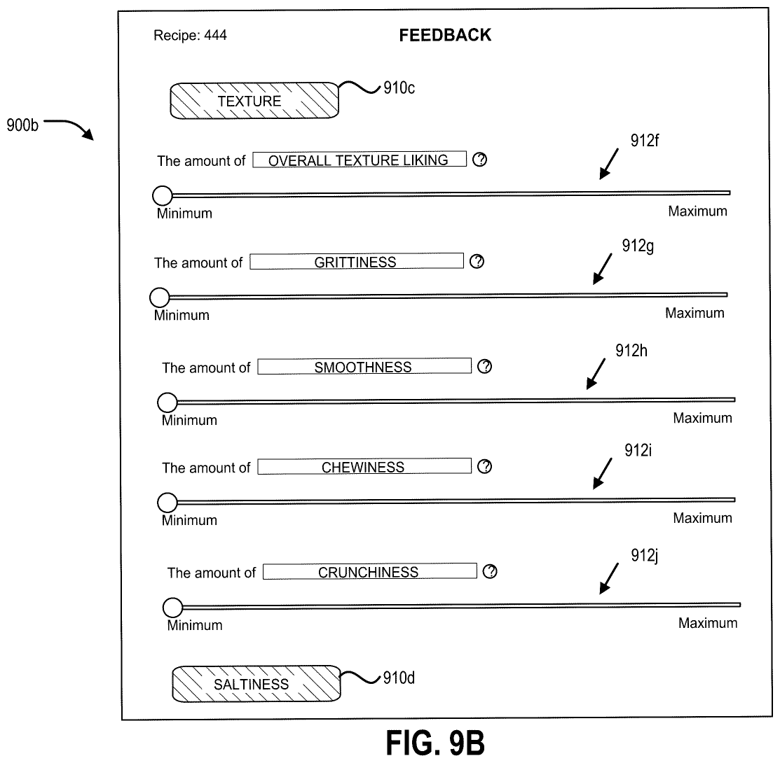

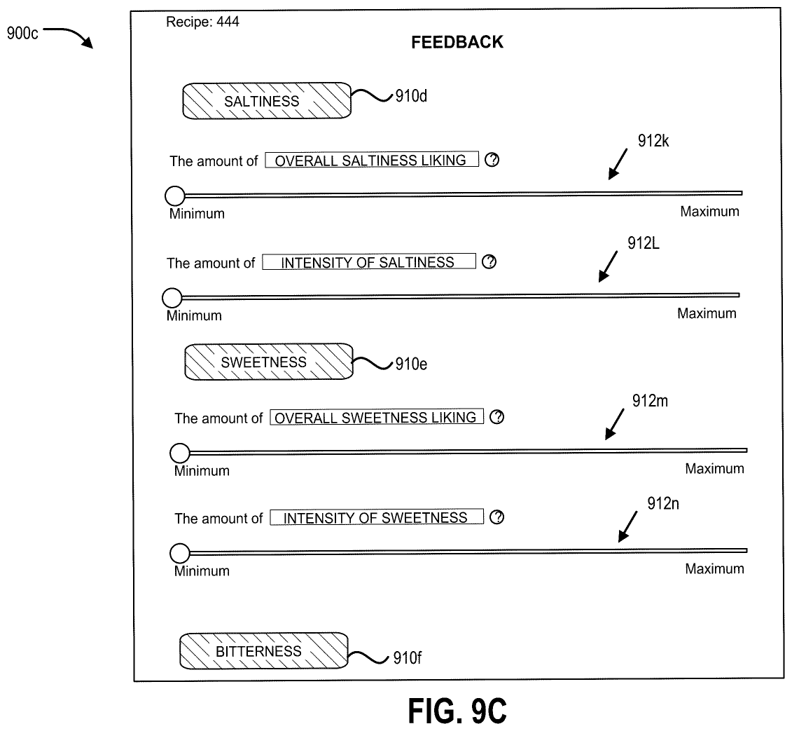

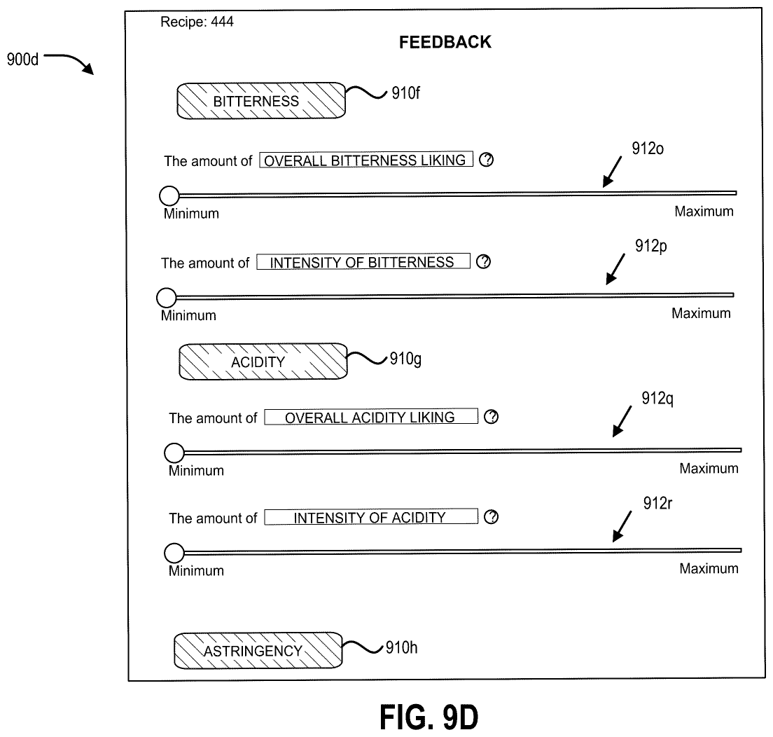

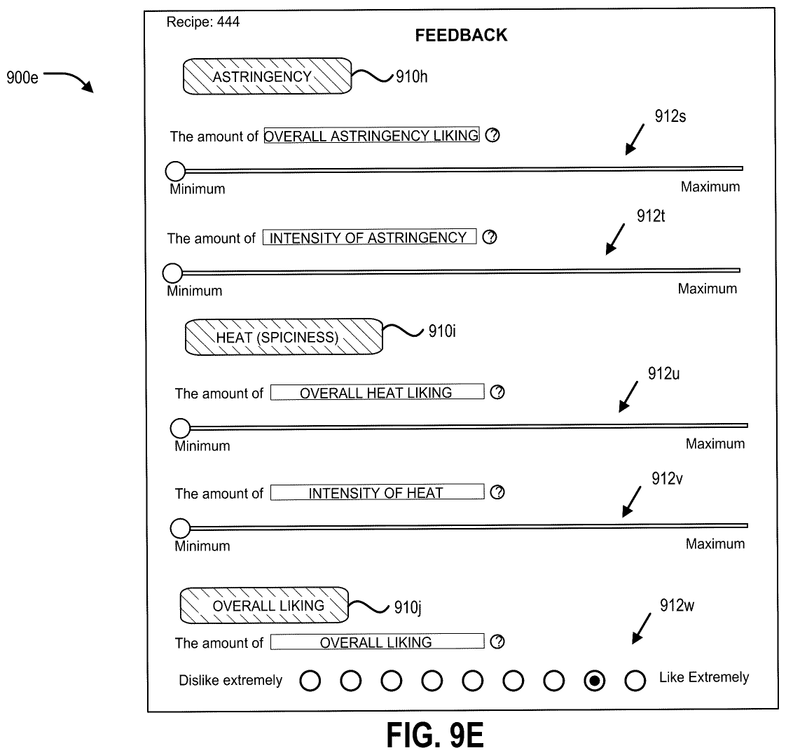

Additional examples of GUI elements and user input that may be utilized to provide feedback for a test sample are described in further detail below with reference to FIGS. 9A-9E.

After client device 110b presents the GUI view for inputting feedback on the given test sample, the user (which as noted may be the given taste tester or someone else acting on behalf of the given taste tester) may utilize the GUI view to provide the given taste tester's feedback for the given test sample in the form of values for the types of quantitative and/or qualitative metrics described above. In turn, the client device 110b may send assessment data indicating the user-specified feedback for the given test sample to the back-end computing platform 102, and at block 806, the back-end computing platform 102 may receive the assessment data indicating the user-specified feedback for the given test sample. In practice, this assessment data may be contained within one or more request messages (e.g., one or more HTTP messages) that are sent over the respective communication path between the client device 110b and the back-end computing platform 102 (which as noted above may include at least one data network), and in at least some implementations, the one or more request messages may be sent via an API. For instance, in some implementations, the full set of assessment data may be contained within a single request message, whereas in other implementations, the assessment data may be divided across multiple request messages. The assessment data may take other forms and/or be received in other manners as well.

At block 808, the back-end computing platform 102 may then store the received assessment data for the given test sample in a data storage layer of the platform (e.g., in a relational database) so that such assessment data can then be accessed by other components of the server-side software 103 (e.g., the product prediction component 105). For example, the back-end computing platform 102 may store the received assessment data for the given test sample in a respective data record that is keyed to an identifier of the given candidate recipe, among other possibilities.

In practice, the foregoing functionality may be repeated for each respective test sample that is evaluated by each taste tester, which may result in the back-end computing platform 102 receiving and storing a respective assessment dataset (e.g., a set of assessment data records) for each candidate recipe in the initial set of candidate recipes.

In some implementations, the product feedback component 106 may cause the back-end computing platform 102 to carry out a similar set of functionality for collecting measurement values for a test sample, which may involve (i) receiving a request from a client device 110 associated with a user (e.g., an individual involved in capturing measurement values) to access a GUI view of the disclosed AIPD software tool for inputting measurement values for a given test sample that was prepared in accordance with a given candidate recipe of the recipe prediction project and was then evaluated using measurement tools, (ii) sending a response to the client device 110 that enables and causes the client device 110 to present the GUI view for inputting measurement values for the given test sample, which may be presented by the client device 110 and utilized by the user to input measurement values for the given test sample, (iii) receiving assessment data indicating the user-input measurement values for the given test sample, (iv) storing the received assessment data for the given test sample in a data storage layer of the platform (e.g., in a relational database) so that such assessment data can then be accessed by other components of the server-side software 103 (e.g., the product prediction component 105). In this respect, if assessment data for the same candidate recipe is received via these two different workflows (e.g., one workflow for feedback and another workflow for measurements), that assessment data will preferably be stored in a manner that allows it to be accessed together as a collective set of assessment data for the candidate recipe (e.g., by storing it in a single data record or keying it to the same candidate recipe identifier).

Further, in some implementations, the back-end computing platform 102 may perform certain processing operations on the assessment data that is collected across the different test samples. For instance, in some implementations, the back-end computing platform 102 may function to aggregate assessment data that is collected for the same candidate recipe into a single data record comprising aggregated assessment data for the candidate recipe. To illustrate with an example, if 5 different taste testers evaluated test samples prepared using the same candidate recipe and provided feedback for those test samples, the back-end computing platform 102 may function to aggregate the assessment data that is received for those test samples by determining an aggregated value of each metric included in the assessment data (e.g., a mean, median, max, min, etc.), such as an aggregated value of a metric related to the target goal, an aggregated value of a metric related to a first sensory attribute, an aggregated value of a metric related to a second sensory attribute, and so on. The measurement values that are collected for the test samples may be aggregated in a similar manner. The back-end computing platform 102 may perform other processing operations on the assessment data that is collected across the different test samples as well.

The functionality that is provided by the product feedback component 106 of the server-side software 103 may take various other forms as well.

Turning now to FIGS. 9A-9E, example GUI views for inputting feedback for a test sample in accordance with the present disclosure is illustrated. For instance, FIG. 9A illustrates a first portion 900a of an example GUI view for inputting feedback comprising input elements that enable a user to input feedback for sensory attributes that are categorized under the headers 910a, 910b, 910c (“Aroma,” “Appearance,” and “Texture”). Specifically, a user can move (i) the slider 912a (e.g., by clicking on the slider 912a and dragging) to the right or left to indicate the user's perception of the sensory attribute “intensity of aroma,” (ii) the slider 912b to the left or right to indicate the user's perception of the sensory attribute “overall aroma liking,” (iii) the slider 912c to the left or right to indicate the user's perception of the sensory attribute “off note” (i.e., the extent to which the user detected an aroma that was not supposed to be detectable in the tested food product, such as the odor of a preservative), (iv) the slider 912d to the left or right to indicate the user's perception of the sensory attribute “overall appearance liking,” and (v) the slider 912e to the left or right to indicate the user's perception of the sensory attribute “overall texture liking.” Furthermore, the user can scroll down from the GUI view 900a to input additional feedback.

FIG. 9B illustrates a second portion 900b of an example GUI view for inputting feedback. The second portion 900b comprises input elements that enable a user to input feedback for sensory attributes that are categorized under the headers 910c, 910d (“Texture” and “Saltiness”). Specifically, a user can move (i) the slider 912f (e.g., by clicking on the slider 912f and dragging) to the right or left to indicate the user's perception of the sensory attribute “overall texture liking,” (i) the slider 912g to the left or right to indicate the user's perception of the sensory attribute “grittiness,” (iii) the slider 912h to the left or right to indicate the user's perception of the sensory attribute “smoothness,” (vi) the slider 912i to the left or right to indicate the user's perception of the sensory attribute “chewiness,” and (v) the slider 912j to the left or right to indicate the user's perception of the sensory attribute “crunchiness.” Furthermore, the user can scroll down from the GUI view 900b to input additional feedback.

FIG. 9C illustrates a third portion 900c of an example GUI view for inputting feedback. The third portion 900c comprises input elements that enable a user to input feedback for sensory attributes that are categorized under the headers 910d, 910e, 910f (“Saltiness,” “Sweetness,” and “Bitterness”). Specifically, a user can move (i) the slider 912k (e.g., by clicking on the slider 912k and dragging) to the right or left to indicate the user's perception of the sensory attribute “Overall saltiness liking,” (ii) the slider 912L to the left or right to indicate the user's perception of the sensory attribute “Intensity of saltiness,” (iii) the slider 912m to the left or right to indicate the user's perception of the sensory attribute “overall sweetness liking,” and (iv) and the slider 912n to the left or right to indicate the user's perception of the sensory attribute “Intensity of sweetness.” Furthermore, the user can scroll down from the GUI view 900c to input additional feedback.

FIG. 9D illustrates a fourth portion 900d of an example GUI view for inputting feedback. The fourth portion 900d comprises input elements that enable a user to input feedback for sensory attributes that are categorized under the headers 910f, 910g, 910h (“Bitterness,” “Acidity,” and “Astringency”). Specifically, a user can move (i) the slider 9120 (e.g., by clicking on the slider 9120 and dragging) to the right or left to indicate the user's perception of the sensory attribute “Overall bitterness liking,” (ii) the slider 912p to the left or right to indicate the user's perception of the sensory attribute “Intensity of bitterness,” (iii) the slider 912q to the left or right to indicate the user's perception of the sensory attribute “overall acidity liking,” and (iv) the slider 912r to the left or right to indicate the user's perception of the sensory attribute “Intensity of acidity.” Furthermore, the user can scroll down from the GUI view 900d to input additional feedback.

FIG. 9E illustrates a fifth portion 900e of an example GUI view for inputting feedback. The fifth portion 900e comprises input elements that enable a user to input feedback for sensory attributes that are categorized under the headers 910h, 910i (“Astringency,” “Heat (spiciness),”) as well as an input element that enables a user to input feedback for “Overall liking” 910j. Specifically, a user can move (i) the slider 912s (e.g., by clicking on the slider 912s and dragging) to the right or left to indicate the user's perception of the sensory attribute “Overall astringency liking,” (ii) the slider 912t to the left or right to indicate the user's perception of the sensory attribute “Intensity of astringency,” (iii) the slider 912u to the left or right to indicate the user's perception of the sensory attribute “overall heat liking,” and (iv) the slider 912v to the left or right to indicate the user's perception of the sensory attribute “Intensity of heat.” Additionally, the user can select one of the radio buttons 912w to indicate the user's feedback for “overall liking.”

As will be recognized by persons of skill in the art, the example GUI views shown in FIGS. 9A-9E are merely illustrative. For example, other types of input elements may be used instead of, or in addition to, the sliders and radio buttons. Other combinations of sensory attributes may be used in other examples and other categorization schemes (or even no categorization scheme) may be applied to the sensory attributes that are used. The inputting feedback for a test sample in accordance with the present disclosure may take various other forms.

After the assessment data for the test samples that were prepared using the initial group of candidate recipes of the recipe prediction project has been collected and stored, that assessment data may be used as a basis for determining whether any of the candidate recipes in the initial group is of sufficient quality to be considered for use in commercially producing the given food product. For instance, a user such as a product developer could perform this task by using a client device 110 to access another GUI view of the disclosed AIPD software tool that presents the collected assessment data for the test samples.

If at least one of the candidate recipes in the initial group is determined to be of sufficient quality to be considered for use in commercially producing the given food product, that candidate recipe may then progress to a next phase of the product cycle where the candidate recipe undergoes additional evaluation, such as validation using consumer science protocols, discriminative tests, and/or and consumer studies. And in such a scenario, it may be unnecessary to predict any further candidate recipes for the recipe prediction project.

On the other hand, if none of the candidate recipes in the initial group is determined to be of sufficient quality to be considered for use in commercially producing the given food product, then the functionality of the product prediction component 105 may be utilized to predict one or more supplemental groups of candidate recipes for evaluation during one or more subsequent runs.

The functionality that is provided by the product prediction component 105 of the server-side software 103 in order to predict a supplemental group of candidate recipes for the recipe prediction project during a subsequent run may be similar to the functionality for predicting the initial group of candidate recipes for the recipe prediction project during the initial run that is described above with reference to FIG. 6, but one key difference is that the set of training data used to train the predictor model and the generator model's underlying predictive model will be different. In particular, during each subsequent run of candidate recipe prediction carried out by the production prediction component 105, the first set of training data for the predictor model that is obtained at block 604 and the second set of training data for the generator model's underlying predictive model that is obtained at block 608 may include an additional channel of training data that is sourced from the assessment data that was collected during evaluation of the one or more prior groups of candidate recipes, which may be combined together with the other channels of training data that were used during the initial run in order to expand the set of training data for the the generator model's underlying predictive model and thereby help to improve the accuracy of the candidate recipe prediction during each subsequent run.

After a supplemental group of candidate recipes is predicted by the product prediction component 105, that supplemental group of candidate recipes may be used to prepare new batches of test samples, which may then be evaluated in a similar manner to that described above. And this cycle may then continue until (i) at least one of the candidate recipes is determined to be of sufficient quality to be considered for use in commercially producing the given food product or (ii) it is determined that there is no viable recipe that has been predicted as part of the recipe prediction project.

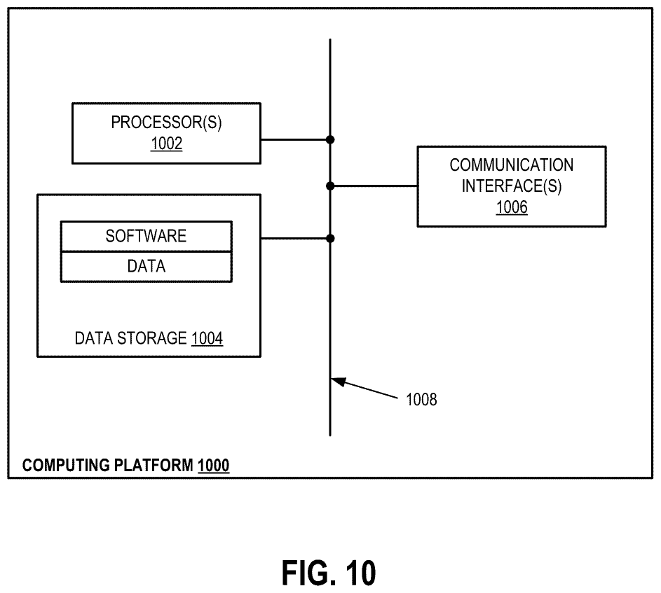

Turning now to FIG. 10, a simplified block diagram is provided to illustrate some structural components that may be included in an example computing platform 1000 that may be configured to perform some or all of the server-side functions disclosed herein. At a high level, computing platform 1000 may generally comprise any one or more computer systems (e.g., one or more servers) that collectively include one or more processors 1002, data storage 1004, and one or more communication interfaces 1006, all of which may be communicatively linked by a communication link 1008 that may take the form of a system bus, a communication network such as a public, private, or hybrid cloud, or some other connection mechanism. Each of these components may take various forms.

For instance, the one or more processors 1002 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 1002 could comprise processing components that are distributed across a plurality of physical computing devices connected via a network, such as a computing cluster of a public, private, or hybrid cloud.

In turn, data storage 1004 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 1004 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 10, data storage 1004 may be capable of storing both (i) program instructions that are executable by the one or more processors 1002 such that the computing platform 1000 is configured to perform any of the various functions disclosed herein (including but not limited to any of the server-side functions discussed above), and (ii) data that may be received, derived, or otherwise stored by computing platform 1000.

The one or more communication interfaces 1006 may comprise one or more interfaces that facilitate communication between computing platform 1000 and other systems or devices, where each such interface may be wired and/or wireless and may communicate according to any of various communication protocols. As examples, the one or more communication interfaces 1006 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the computing platform 1000 may additionally have an I/O interface that includes or provides connectivity to I/O components that facilitate user interaction with the computing platform 1000, such as a keyboard, a mouse, a trackpad, a display screen, a touch-sensitive interface, a stylus, a virtual-reality headset, and/or one or more speaker components, among other possibilities.

It should be understood that computing platform 1000 is one example of a computing platform that may be used with the embodiments described herein. Numerous other arrangements are possible and contemplated herein. For instance, in other embodiments, the computing platform 1000 may include additional components not pictured and/or more or less of the pictured components.

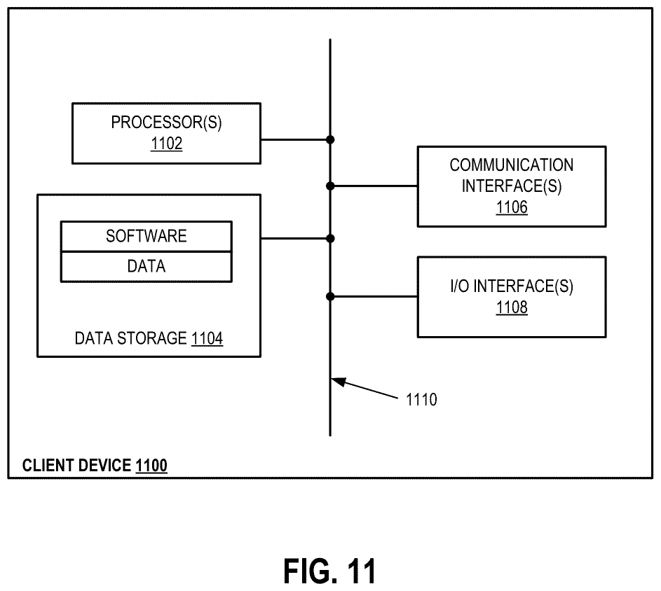

Turning next to FIG. 11, a simplified block diagram is provided to illustrate some structural components that may be included in an example client device 1100 that may be configured to perform some or all of the client-side functions disclosed herein. At a high level, the example client device 1100 may include one or more processors 1102, data storage 1104, one or more communication interfaces 1106, and an I/O interface 1108, all of which may be communicatively linked by a communication link 1110 that may take the form a system bus and/or some other connection mechanism. Each of these components may take various forms.

For instance, the one or more processors 1102 of the example client device 1100 may comprise one or more processor components, such as one or more CPUs, GPUs, ASICs, DSPs, and/or programmable logic devices such as FPGAs, among other possible types of processing components

In turn, the data storage 1104 of the example client device 1100 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 11, data storage 1104 may be capable of storing both (i) program instructions that are executable by the one or more processors 1102 of the example client device 1100 such that the client device 1100 is configured to perform any of the various functions disclosed herein (including but not limited to any of the client-side functions discussed above), and (ii) data that may be received, derived, or otherwise stored by the client device 1100.

The one or more communication interfaces 1106 may comprise one or more interfaces that facilitate communication between the client device 1100 and other systems or devices, where each such interface may be wired and/or wireless and may communicate according to any of various communication protocols. As examples, the one or more communication interfaces 1106 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 1108 may generally take the form of (i) one or more input interfaces that are configured to receive and/or capture information at the example client device 1100 and (ii) one or more output interfaces that are configured to output information from the example client device 1100 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of I/O interface may include or provide connectivity to output components such as a display screen and/or an audio speaker, among other possibilities.

It should be understood that the example client device 1100 is one example of a client device that may be used with the example embodiments described herein. Numerous other arrangements are possible and contemplated herein. For instance, in other embodiments, the example client device 1100 may include additional components not pictured and/or more or fewer of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

1. A computing platform comprising:
at least one network interface;
at least one processor;
at least one non-transitory computer-readable medium; and
program instructions stored on the at least one non-transitory computer-readable medium that, when executed by the at least one processor, cause the computing platform to:
receive, from a first client device via a first communication path comprising at least one data network, an indication of configuration parameters for predicting candidate recipes for a food product, wherein the configuration parameters include at least (i) a set of ingredients to include in the candidate recipes, (ii) at least one target variable for the candidate recipes that quantifies an extent to which the candidate recipes achieve a target goal associated with the food product, (iii) a set of constraints for the candidate recipes that impose limits on amounts of ingredients included in the candidate recipes, and (iv) a set of assessment variables that are to be evaluated during testing of the candidate recipes, wherein the set of assessment variables includes variables corresponding to sensory attributes for which feedback is to be gathered from taste testers of test samples produced from the candidate recipes;
based on a first subset of the configuration parameters and a first set of training data, carry out a multi-task machine learning process to train a predictor model that is configured to output, for a candidate recipe that is passed as input to the predictive model, (i) a predicted value of the at least one target variable and (ii) predicted values of a given subset of the assessment variables, wherein the first set of training data comprises a first set of training data records that each includes (a) a combination of amounts for at least a subset of the set of ingredients, (b) a value for the at least one target variable, and (c) values for the given subset of the assessment variables, and wherein multi-task machine learning process functions to identify and exploit correlations between the at least one target variable and the given subset of assessment variables;
utilize a generator model and the predictor model to select, from a multi-dimensional space of possible recipes having a number of dimensions that corresponds to a number of ingredients in the set of ingredients, a first group of candidate recipes for the food product in which each respective candidate recipe comprises a respective combination of amounts for the set of ingredients by:
utilizing the generator model to carry out a first iteration of a single-task machine learning process to train a first instance of an underlying predictive model based on a second subset of the configuration parameters and a second set of training data, wherein the second set of training data comprises a second set of training data records that each includes (a) a combination of amounts for at least a subset of the set of ingredients and (b) a value for the at least one target variable, and wherein the first instance of the underlying predictive model functions to output a first version of (i) predicted values of the at least one target variable for the multi-dimensional space of possible recipes and (ii) uncertainty estimates for the predicted values;
utilizing the generator model to carry out a first iteration of an optimization process to select a first candidate recipe to include in the first group of candidate recipes from the multi-dimensional space of possible recipes based on (i) a balancing between the predicted values and the uncertainty estimates output by the first instance of the underlying predictive model and (ii) the set of the constraints, wherein the first candidate recipe comprises a first combination of amounts for the set of ingredients;
utilizing the predictor model to determine a first predicted value of the at least one target variable for the first candidate recipe;
updating the second set of training data by adding, to the second set of training data records, a first new training data record that includes (a) the first combination of amounts for the set of ingredients and (b) the first predicted value of the at least one target variable for the first candidate recipe;
utilizing the generator model to carry out a second iteration of the single-task machine learning process to train a second instance of the underlying predictive model based on the second subset of the configuration parameters and the updated second set of training data that includes the first new training data record, wherein the second instance of the underlying predictive model functions to output a second version of (i) predicted values of the at least one target variable for the multi-dimensional space of possible recipes and (ii) uncertainty estimates for the predicted values; and
utilizing the generator model to carry out a second iteration of the optimization process to select a second candidate recipe to include in the first group of candidate recipes from the multi-dimensional space of possible recipes based on (i) a balancing between the predicted values and the uncertainty estimates output by the second instance of the underlying predictive model and (ii) the set of the constraints, wherein the second candidate recipe comprises a second combination of amounts for the set of ingredients; and
transmit, to a second client device via a second communication path comprising at least one data network, one or more messages that collectively cause the second client device to display the first group of candidate recipes for the food product.

2. (canceled)

3. The computing platform of claim 1, wherein the set of assessment variables that are to be evaluated during testing of the candidate recipes further includes variables corresponding to a set of measurements that are to be taken during testing of the candidate recipes.

4. (canceled)

5. The computing platform of claim 1, wherein the set of constraints includes one or more of:
a respective constraint on an amount of each respective ingredient in at least a subset of the set of ingredients;
a constraint on a combined amount of multiple ingredients within a given ingredient category;
a constraint on a cost of the candidate recipes;
a constraint on a nutrition attribute of the candidate recipes; or
a constraint on a sustainability attribute of the candidate recipes.

6. (canceled)

7. (canceled)

8. The computing platform of claim 1, wherein the at least one target variable comprises at least one of (i) a variable indicating consumer enjoyment of the food product, (ii) variable indicating cost of the food product, or (iii) a variable indicating environmental impact of the food product.

9. (canceled)

10. (canceled)

11. The computing platform of claim 1, wherein the first client device and the second client device comprise a same client device.

12. A non-transitory computer-readable medium comprising program instructions that, when executed by at least one processor, cause a computing platform to:
receive, from a first client device via a first communication path comprising at least one data network, an indication of configuration parameters for predicting candidate recipes for a food product, wherein the configuration parameters include at least (i) a set of ingredients to include in the candidate recipes, (ii) at least one target variable for the candidate recipes that quantifies an extent to which the candidate recipes achieve a target goal associated with the food product, (iii) a set of constraints for the candidate recipes that impose limits on amounts of ingredients included in the candidate recipes, and (iv) a set of assessment variables that are to be evaluated during testing of the candidate recipes, wherein the set of assessment variables includes variables corresponding to sensory attributes for which feedback is to be gathered from taste testers of test samples produced from the candidate recipes;
based on a first subset of the configuration parameters and a first set of training data, carry out a multi-task machine learning process to train a predictor model that is configured to output, for a candidate recipe that is passed as input to the predictive model, (i) a predicted value of the at least one target variable and (ii) predicted values of a given subset of the assessment variables, wherein the first set of training data comprises a first set of training data records that each includes (a) a combination of amounts for at least a subset of the set of ingredients, (b) a value for the at least one target variable, and (c) values for the given subset of the assessment variables, and wherein multi-task machine learning process functions to identify and exploit correlations between the at least one target variable and the given subset of assessment variables;
utilize a generator model and the predictor model to select, from a multi-dimensional space of possible recipes having a number of dimensions that corresponds to a number of ingredients in the set of ingredients, a first group of candidate recipes for the food product in which each respective candidate recipe comprises a respective combination of amounts for the set of ingredients by:
utilizing the generator model to carry out a first iteration of a single-task machine learning process to train a first instance of an underlying predictive model based on a second subset of the configuration parameters and a second set of training data, wherein the second set of training data comprises a second set of training data records that each includes (a) a combination of amounts for at least a subset of the set of ingredients and (b) a value for the at least one target variable, and wherein the first instance of the underlying predictive model functions to output a first version of (i) predicted values of the at least one target variable for the multi-dimensional space of possible recipes and (ii) uncertainty estimates for the predicted values;
utilizing the generator model to carry out a first iteration of an optimization process to select a first candidate recipe to include in the first group of candidate recipes from the multi-dimensional space of possible recipes based on (i) a balancing between the predicted values and the uncertainty estimates output by the first instance of the underlying predictive model and (ii) the set of the constraints, wherein the first candidate recipe comprises a first combination of amounts for the set of ingredients;
utilizing the predictor model to determine a first predicted value of the at least one target variable for the first candidate recipe;
updating the second set of training data by adding, to the second set of training data records, a first new training data record that includes (a) the first combination of amounts for the set of ingredients and (b) the first predicted value of the at least one target variable for the first candidate recipe;
utilizing the generator model to carry out a second iteration of the single-task machine learning process to train a second instance of the underlying predictive model based on the second subset of the configuration parameters and the updated second set of training data that includes the first new training data record, wherein the second instance of the underlying predictive model functions to output a second version of (i) predicted values of the at least one target variable for the multi-dimensional space of possible recipes and (ii) uncertainty estimates for the predicted values; and
utilizing the generator model to carry out a second iteration of the optimization process to select a second candidate recipe to include in the first group of candidate recipes from the multi-dimensional space of possible recipes based on (i) a balancing between the predicted values and the uncertainty estimates output by the second instance of the underlying predictive model and (ii) the set of the constraints, wherein the second candidate recipe comprises a second combination of amounts for the set of ingredients; and
transmit, to a second client device via a second communication path comprising at least one data network, one or more messages that collectively cause the second client device to display the first group of candidate recipes for the food product.

13. (canceled)

14. The non-transitory computer-readable medium of claim 12, wherein the set of assessment variables that are to be evaluated during testing of the candidate recipes further includes variables corresponding to a set of measurements that are to be taken during testing of the candidate recipes.

15. The non-transitory computer-readable medium of claim 12, wherein the set of constraints includes one or more of:
a respective constraint on an amount of each respective ingredient in at least a subset of the set of ingredients;
a constraint on a combined amount of multiple ingredients within a given ingredient category;
a constraint on a cost of the candidate recipes;
a constraint on a nutrition attribute of the candidate recipes; or
a constraint on a sustainability attribute of the candidate recipes.

16. (canceled)

17. (canceled)

18. The non-transitory computer-readable medium of claim 12, wherein the at least one target variable comprises at least one of (i) a variable indicating consumer enjoyment of the food product, (ii) variable indicating cost of the food product, or (iii) a variable indicating environmental impact of the food product.

19. A computer-implemented method comprising:
receiving, from a first client device via a first communication path comprising at least one data network, an indication of configuration parameters for predicting candidate recipes for a food product, wherein the configuration parameters include at least (i) a set of ingredients to include in the candidate recipes, (ii) at least one target variable for the candidate recipes that quantifies an extent to which the candidate recipes achieve a target goal associated with the food product, (iii) a set of constraints for the candidate recipes that impose limits on amounts of ingredients included in the candidate recipes, and (iv) a set of assessment variables that are to be evaluated during testing of the candidate recipes, wherein the set of assessment variables includes variables corresponding to sensory attributes for which feedback is to be gathered from taste testers of test samples produced from the candidate recipes;
based on a first subset of the configuration parameters and a first set of training data, carrying out a multi-task machine learning process to train a predictor model that is configured to output, for a candidate recipe that is passed as input to the predictive model, (i) a predicted value of the at least one target variable and (ii) predicted values of a given subset of the assessment variables, wherein the first set of training data comprises a first set of training data records that each includes (a) a combination of amounts for at least a subset of the set of ingredients, (b) a value for the at least one target variable, and (c) values for the given subset of the assessment variables, and wherein multi-task machine learning process functions to identify and exploit correlations between the at least one target variable and the given subset of assessment variables;
utilizing a generator model and the predictor model to select, from a multi-dimensional space of possible recipes having a number of dimensions that corresponds to a number of ingredients in the set of ingredients, a first group of candidate recipes for the food product in which each respective candidate recipe comprises a respective combination of amounts for the set of ingredients by:
utilizing the generator model to carry out a first iteration of a single-task machine learning process to train a first instance of an underlying predictive model based on a second subset of the configuration parameters and a second set of training data, wherein the second set of training data comprises a second set of training data records that each includes (a) a combination of amounts for at least a subset of the set of ingredients and (b) a value for the at least one target variable, and wherein the first instance of the underlying predictive model functions to output a first version of (i) predicted values of the at least one target variable for the multi-dimensional space of possible recipes and (ii) uncertainty estimates for the predicted values;
utilizing the generator model to carry out a first iteration of an optimization process to select a first candidate recipe to include in the first group of candidate recipes from the multi-dimensional space of possible recipes based on (i) a balancing between the predicted values and the uncertainty estimates output by the first instance of the underlying predictive model and (ii) the set of the constraints, wherein the first candidate recipe comprises a first combination of amounts for the set of ingredients;
utilizing the predictor model to determine a first predicted value of the at least one target variable for the first candidate recipe;
updating the second set of training data by adding, to the second set of training data records, a first new training data record that includes (a) the first combination of amounts for the set of ingredients and (b) the first predicted value of the at least one target variable for the first candidate recipe;
utilizing the generator model to carry out a second iteration of the single-task machine learning process to train a second instance of the underlying predictive model based on the second subset of the configuration parameters and the updated second set of training data that includes the first new training data record, wherein the second instance of the underlying predictive model functions to output a second version of (i) predicted values of the at least one target variable for the multi-dimensional space of possible recipes and (ii) uncertainty estimates for the predicted values; and
utilizing the generator model to carry out a second iteration of the optimization process to select a second candidate recipe to include in the first group of candidate recipes from the multi-dimensional space of possible recipes based on (i) a balancing between the predicted values and the uncertainty estimates output by the second instance of the underlying predictive model and (ii) the set of the constraints, wherein the second candidate recipe comprises a second combination of amounts for the set of ingredients; and
transmitting, to a second client device via a second communication path comprising at least one data network, one or more messages that collectively cause the second client device to display the first group of candidate recipes for the food product.

20. (canceled)

21. The computer-implemented method of claim 19, wherein the set of assessment variables that are to be evaluated during testing of the candidate recipes further includes variables corresponding to a set of measurements that are to be taken during testing of the candidate recipes.

22. The computer-implemented method of claim 19, wherein the set of constraints includes one or more of:
a respective constraint on an amount of each respective ingredient in at least a subset of the set of ingredients;
a constraint on a combined amount of multiple ingredients within a given ingredient category;
a constraint on a cost of the candidate recipes;
a constraint on a nutrition attribute of the candidate recipes; or
a constraint on a sustainability attribute of the candidate recipes.

23. (canceled)

24. The computing platform of claim 1, wherein the first group of candidate recipes for the food product are thereafter utilized to prepare test samples of the food product for evaluation by taste tasters.

25. The computing platform of claim 1, wherein the one or more messages that collectively cause the second client device to display the first group of candidate recipes for the food product comprise one or more messages that collectively cause the second client device to display a visualization comprising, for each respective candidate recipe in the first group of candidate recipes, a respective graph that shows the respective combination of amounts for the set of ingredients that make up the respective candidate recipe.

26. The computing platform of claim 1, further comprising program instructions stored on the at least one non-transitory computer-readable medium that, when executed by the at least one processor, cause the computing platform to:
prior to receiving the indication of the configuration parameters for predicting candidate recipes for the food product, transmit one or more messages that collectively cause the first client device to display a graphical user interface (GUI) for inputting the configuration parameters for predicting candidate recipes for the food product, wherein the GUI includes input elements for specifying (i) the set of ingredients, (ii) the at least one target variable, (iii) the set of constraints, and (iv) the set of assessment variables that are to be evaluated during testing of the candidate recipes.

27. The computing platform of claim 1, wherein:
the multi-task machine learning process comprises a Gaussian process regression technique that trains the predictor model in a multi-task learning setting;
the single-task machine learning process comprises a Gaussian process regression technique that trains each instance of the underlying predictive model in a single-task learning setting; and
the optimization process comprises a Bayesian optimization process.

28. The computing platform of claim 1, further comprising program instructions stored on the at least one non-transitory computer-readable medium that, when executed by the at least one processor, cause the computing platform to:
receive assessment data for the first group of candidate recipes that comprises, for each respective candidate recipe in the first group of candidate recipes, respective feedback data for the at least one target variable and the set of sensory attributes that was gathered from taste testers of test samples produced from the respective candidate recipe;
based on the received assessment data, generate a third set of training data by adding, to the first set of training data records, at least one new training data record for each respective candidate recipe in the first group of candidate recipes that includes (a) the respective combination of amounts for the set of ingredients included in the respective candidate recipe, (b) a value of the at least one target variable for the respective candidate recipe that is determined based at least in part on the respective feedback data that was gathered from the taste testers of the test samples produced from the respective candidate recipe, and (c) values for the given subset of the assessment variables that are determined based at least in part on the respective feedback data that was gathered from the taste testers of the test samples produced from the respective candidate recipe;
based on the received assessment data, generate a fourth set of training data by adding, to the second set of training data records, at least one new training data record for each respective candidate recipe in the first group of candidate recipes that includes (a) the respective combination of amounts for the set of ingredients included in the respective candidate recipe, and (b) a value of the at least one target variable for the respective candidate recipe that is determined at least in part based on the respective data that was gathered from the taste testers of the test samples produced from the respective candidate recipe;
based on the first subset of the configuration parameters and the third set of training data, carry out another instance of the multi-task machine learning process to train an updated predictor model that is configured to output, for a candidate recipe that is passed as input to the updated predictive model, (i) a predicted value of the at least one target variable and (ii) predicted values of a given subset of the assessment variables; and
utilize the generator model and the updated predictor model to select, from the multi-dimensional space of possible recipes, a second group of candidate recipes for the food product in which each respective candidate recipe comprises a respective combination of amounts for the set of ingredients by:
utilizing the generator model to carry out a third iteration of the single-task machine learning process to train a third instance of the underlying predictive model based on the second subset of the configuration parameters and the fourth set of training data, wherein the third instance of the underlying predictive model functions to output a third version of (i) predicted values of the at least one target variable for the multi-dimensional space of possible recipes and (ii) uncertainty estimates for the predicted values;
utilizing the generator model to carry out a third iteration of the optimization process to select a third candidate recipe to include in the second group of candidate recipes from the multi-dimensional space of possible recipes based on a balancing between the predicted values and the uncertainty estimates output by the third instance of the underlying predictive model and the set of the constraints, wherein the third candidate recipe comprises a third combination of amounts for the set of ingredients;
utilizing the updated predictor model to determine a third predicted value of the at least one target variable for the third candidate recipe;
updating the fourth set of training data by adding, to the fourth set of training data records, a third new training data record that includes (a) the third combination of amounts for the set of ingredients and (b) the third predicted value of the at least one target variable for the third candidate recipe;
utilizing the generator model to carry out a fourth iteration of the single-task machine learning process to train a fourth instance of the underlying predictive model based on the second subset of the configuration parameters and the updated fourth set of training data that includes the third new training data record; and
utilizing the generator model to carry out a fourth iteration of the optimization process to select a fourth candidate recipe to include in the second group of candidate recipes from the multi-dimensional space of possible recipes based on a balancing between the predicted values and the uncertainty estimates output by the fourth instance of the underlying predictive model and the set of the constraints.

29. The computing platform of claim 28, further comprising program instructions stored on the at least one non-transitory computer-readable medium that, when executed by the at least one processor, cause the computing platform to:
prior to receiving the assessment data for the first group of candidate recipes, cause one or more client devices to display a graphical user interface (GUI) for gathering the feedback data from the taste testers of the test samples produced from the first group of candidate recipes, wherein the GUI includes input elements for specifying, for each respective candidate recipe in the first group of candidate recipes, respective feedback values for the at least one target variable and the set of sensory attributes.

30. The non-transitory computer-readable medium of claim 12, further comprising program instructions that, when executed by the at least one processor, cause the computing platform to:
receive assessment data for the first group of candidate recipes that comprises, for each respective candidate recipe in the first group of candidate recipes, respective feedback data for the at least one target variable and the set of sensory attributes that was gathered from taste testers of test samples produced from the respective candidate recipe;
based on the received assessment data, generate a third set of training data by adding, to the first set of training data records, at least one new training data record for each respective candidate recipe in the first group of candidate recipes that includes (a) the respective combination of amounts for the set of ingredients included in the respective candidate recipe, (b) a value of the at least one target variable for the respective candidate recipe that is determined based at least in part on the respective feedback data that was gathered from the taste testers of the test samples produced from the respective candidate recipe, and (c) values for the given subset of the assessment variables that are determined based at least in part on the respective feedback data that was gathered from the taste testers of the test samples produced from the respective candidate recipe;
based on the received assessment data, generate a fourth set of training data by adding, to the second set of training data records, at least one new training data record for each respective candidate recipe in the first group of candidate recipes that includes (a) the respective combination of amounts for the set of ingredients included in the respective candidate recipe, and (b) a value of the at least one target variable for the respective candidate recipe that is determined at least in part based on the respective data that was feedback data that was gathered from the taste testers of the test samples produced from the respective candidate recipe;
based on the first subset of the configuration parameters and the third set of training data, carry out another instance of the multi-task machine learning process to train an updated predictor model that is configured to output, for a candidate recipe that is passed as input to the updated predictive model, (i) a predicted value of the at least one target variable and (ii) predicted values of a given subset of the assessment variables; and
utilize the generator model and the updated predictor model to select, from the multi-dimensional space of possible recipes, a second group of candidate recipes for the food product in which each respective candidate recipe comprises a respective combination of amounts for the set of ingredients by:
utilizing the generator model to carry out a third iteration of the single-task machine learning process to train a third instance of the underlying predictive model based on the second subset of the configuration parameters and the fourth set of training data, wherein the third instance of the underlying predictive model functions to output a third version of (i) predicted values of the at least one target variable for the multi-dimensional space of possible recipes and (ii) uncertainty estimates for the predicted values;
utilizing the generator model to carry out a third iteration of the optimization process to select a third candidate recipe to include in the second group of candidate recipes from the multi-dimensional space of possible recipes based on a balancing between the predicted values and the uncertainty estimates output by the third instance of the underlying predictive model and the set of the constraints, wherein the third candidate recipe comprises a third combination of amounts for the set of ingredients;
utilizing the updated predictor model to determine a third predicted value of the at least one target variable for the third candidate recipe;
updating the fourth set of training data by adding, to the fourth set of training data records, a third new training data record that includes (a) the third combination of amounts for the set of ingredients and (b) the third predicted value of the at least one target variable for the third candidate recipe;
utilizing the generator model to carry out a fourth iteration of the single-task machine learning process to train a fourth instance of the underlying predictive model based on the second subset of the configuration parameters and the updated fourth set of training data that includes the third new training data record; and
utilizing the generator model to carry out a fourth iteration of the optimization process to select a fourth candidate recipe to include in the second group of candidate recipes from the multi-dimensional space of possible recipes based on a balancing between the predicted values and the uncertainty estimates output by the fourth instance of the underlying predictive model and the set of the constraints.

31. The computer-implemented method of claim 19, further comprising:
receiving assessment data for the first group of candidate recipes that comprises, for each respective candidate recipe in the first group of candidate recipes, respective feedback data for the at least one target variable and the set of sensory attributes that was gathered from taste testers of test samples produced from the respective candidate recipe;
based on the received assessment data, generating a third set of training data by adding, to the first set of training data records, at least one new training data record for each respective candidate recipe in the first group of candidate recipes that includes (a) the respective combination of amounts for the set of ingredients included in the respective candidate recipe, (b) a value of the at least one target variable for the respective candidate recipe that is determined based at least in part on the respective feedback data that was gathered from the taste testers of the test samples produced from the respective candidate recipe, and (c) values for the given subset of the assessment variables that are determined based at least in part on the respective feedback data that was gathered from the taste testers of the test samples produced from the respective candidate recipe;
based on the received assessment data, generating a fourth set of training data by adding, to the second set of training data records, at least one new training data record for each respective candidate recipe in the first group of candidate recipes that includes (a) the respective combination of amounts for the set of ingredients included in the respective candidate recipe, and (b) a value of the at least one target variable for the respective candidate recipe that is determined at least in part based on the respective feedback data that was gathered from the taste testers of the test samples produced from the respective candidate recipe;
based on the first subset of the configuration parameters and the third set of training data, carrying out another instance of the multi-task machine learning process to train an updated predictor model that is configured to output, for a candidate recipe that is passed as input to the updated predictive model, (i) a predicted value of the at least one target variable and (ii) predicted values of a given subset of the assessment variables; and
utilizing the generator model and the updated predictor model to select, from the multi-dimensional space of possible recipes, a second group of candidate recipes for the food product in which each respective candidate recipe comprises a respective combination of amounts for the set of ingredients by:
utilizing the generator model to carry out a third iteration of the single-task machine learning process to train a third instance of the underlying predictive model based on the second subset of the configuration parameters and the fourth set of training data, wherein the third instance of the underlying predictive model functions to output a third version of (i) predicted values of the at least one target variable for the multi-dimensional space of possible recipes and (ii) uncertainty estimates for the predicted values;
utilizing the generator model to carry out a third iteration of the optimization process to select a third candidate recipe to include in the second group of candidate recipes from the multi-dimensional space of possible recipes based on a balancing between the predicted values and the uncertainty estimates output by the third instance of the underlying predictive model and the set of the constraints, wherein the third candidate recipe comprises a third combination of amounts for the set of ingredients;
utilizing the updated predictor model to determine a third predicted value of the at least one target variable for the third candidate recipe;
updating the fourth set of training data by adding, to the fourth set of training data records, a third new training data record that includes (a) the third combination of amounts for the set of ingredients and (b) the third predicted value of the at least one target variable for the third candidate recipe;
utilizing the generator model to carry out a fourth iteration of the single-task machine learning process to train a fourth instance of the underlying predictive model based on the second subset of the configuration parameters and the updated fourth set of training data that includes the third new training data record; and
utilizing the generator model to carry out a fourth iteration of the optimization process to select a fourth candidate recipe to include in the second group of candidate recipes from the multi-dimensional space of possible recipes based on a balancing between the predicted values and the uncertainty estimates output by the fourth instance of the underlying predictive model and the set of the constraints.
